(19) United States
(12) Patent Application Publication
(10) Pub. No.: US 2026/0075441 A1
(43) Pub. Date: Mar. 12, 2026

(54) USER EQUIPMENT-ASSISTED RECONFIGURATIONS

(71) Applicant: QUALCOMM Incorporated, San Diego, CA (US)

(72) Inventors: Sundaresan TAMBARAM KAILASAM, San Diego, CA (US); Daniel AMERGA, San Diego, CA (US); Kavinkadhirselvan ANGAPPAN, San Diego, CA (US); Mona AGRAWAL, San Diego, CA (US); Sindhu SATYAN, San Diego, CA (US); Liangchi HSU, San Diego, CA (US); Ozcan OZTURK, San Diego, CA (US)

(21) Appl. No.: 18/828,842

(22) Filed: Sep. 9, 2024

(51) Int. Cl. H04W 24/02; H04W 8/22; H04W 76/20; H04W 76/30

(52) U.S. Cl. CPC H04W 24/02; H04W 8/22; H04W 76/20; H04W 76/30

(57) ABSTRACT

Methods, systems, and devices for wireless communications are described. A user equipment (UE) may receive, from a network entity, a first message that indicates a configuration including a set of parameters. The set of parameters may include a first subset of one or more parameters and a second subset of one or more parameters. One or more parameters of the first subset of one or more parameters may be modifiable by the UE. The UE may modify a value of at least one parameter of the first subset of one or more parameters based on a set of one or more capabilities of the UE, a set of one or more conditions at the UE, or both. The UE may transmit a second message that indicates the modified value of the at least one parameter. The UE may receive a third message that indicates feedback based on the second message.

### FIELD OF TECHNOLOGY

The following relates to wireless communications, including user equipment (UE)-assisted reconfigurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a first message that indicates a configuration including a set of parameters, where the set of parameters includes a first subset of one or more parameters and a second subset of one or more parameters, where one or more parameters of the first subset of one or more parameters are modifiable by the UE, transmitting a second message that indicates a modified value of at least one parameter of the first subset of one or more parameters, and receiving a third message that indicates feedback based on the second message.

A UE for wireless communication is described. The UE may include one or more memories storing processor executable code, and one or more processors coupled with the one or more memories. The one or more processors may individually or collectively be operable to execute the code to cause the UE to receive a first message that indicates a configuration including a set of parameters, where the set of parameters includes a first subset of one or more parameters and a second subset of one or more parameters, where one or more parameters of the first subset of one or more parameters are modifiable by the UE, transmit a second message that indicates a modified value of at least one parameter of the first subset of one or more parameters, and receive a third message that indicates feedback based on the second message.

Another UE for wireless communication is described. The UE may include means for receiving a first message that indicates a configuration including a set of parameters, where the set of parameters includes a first subset of one or more parameters and a second subset of one or more parameters, where one or more parameters of the first subset of one or more parameters are modifiable by the UE, means for transmitting a second message that indicates a modified value of at least one parameter of the first subset of one or more parameters, and means for receiving a third message that indicates feedback based on the second message.

A non-transitory computer-readable medium storing code for wireless communication is described. The code may include instructions executable by one or more processors to receive a first message that indicates a configuration including a set of parameters, where the set of parameters includes a first subset of one or more parameters and a second subset of one or more parameters, where one or more parameters of the first subset of one or more parameters are modifiable by the UE, transmit a second message that indicates a modified value of at least one parameter of the first subset of one or more parameters, and receive a third message that indicates feedback based on the second message.

Some examples of the method, UEs, and non-transitory computer-readable medium described herein may further include operations, features, means, or instructions for identifying the one or more parameters of the first subset of one or more parameters that may be modifiable by the UE based on the configuration.

Some examples of the method, UEs, and non-transitory computer-readable medium described herein may further include operations, features, means, or instructions for modifying a value of the at least one parameter based on a set of one or more capabilities of the UE or a set of one or more conditions at the UE, or any combination thereof.

In some examples of the method, UEs, and non-transitory computer-readable medium described herein, and the method, apparatuses, and non-transitory computer-readable medium may include further operations, features, means, or instructions for releasing at least one information element (IE) of a set of one or more IEs, where the at least one IE corresponds to the at least one parameter, setting at least one missing IE of the set of one or more IEs to a default value, where the at least one missing IE corresponds to the at least one parameter, overwriting the value of the at least one parameter based on the at least one parameter being unsupported by the set of one or more capabilities of the UE, setting the value of the at least one parameter to a value selected from one or more allowed values based on a performance metric of the UE and one or more quality of service (QoS) metrics, and enabling support for the at least one parameter based on the set of one or more capabilities of the UE, where at least one capability of the set of one or more capabilities indicates at least one of a supported carrier or a supported public land mobile network.

In some examples of the method, UEs, and non-transitory computer-readable medium described herein, the feedback indicates an acceptance or a rejection of the modified value of the at least one parameter.

In some examples of the method, UEs, and non-transitory computer-readable medium described herein, the first message includes at least one of a radio resource control (RRC) setup message, an RRC setup complete message, or an RRC reconfiguration message and the third message includes at least one of an RRC setup complete message, an RRC reject message, an RRC release message, or an RRC reconfiguration complete message.

Some examples of the method, UEs, and non-transitory computer-readable medium described herein may further include operations, features, means, or instructions for modifying a value of the at least one parameter based on a validation failure of the one or more parameters of the first subset of one or more parameters.

In some examples of the method, UEs, and non-transitory computer-readable medium described herein, the modified value of the at least one parameter may be based on a learning model.

Some examples of the method, UEs, and non-transitory computer-readable medium described herein may further include operations, features, means, or instructions for transmitting a report including capability information that indicates whether the UE supports a learning model for reconfiguration of the one or more parameters of the first subset of one or more parameters.

In some examples of the method, UEs, and non-transitory computer-readable medium described herein, the modified value of the at least one parameter may be associated with an IE, a set of IEs, a carrier, or a set of carriers, or any combination thereof.

In some examples of the method, UEs, and non-transitory computer-readable medium described herein, the modified value of the at least one parameter corresponds to a removal of a carrier.

A method for wireless communication by a network entity is described. The method may include transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE, obtaining a second message that indicates a modified value of at least one parameter of the first subset of one or more parameters, and transmitting a third message that indicates feedback based on the second message.

A network entity for wireless communication is described. The network entity may include one or more memories storing processor executable code, and one or more processors coupled with the one or more memories. The one or more processors may individually or collectively be operable to execute the code to cause the network entity to transmit, to a UE, a first message that indicates a configuration including a set of parameters, where the set of parameters includes a first subset of one or more parameters and a second subset of one or more parameters, where one or more parameters of the first subset of one or more parameters are modifiable by the UE, obtain a second message that indicates a modified value of at least one parameter of the first subset of one or more parameters, and transmit a third message that indicates feedback based on the second message.

Another network entity for wireless communication is described. The network entity may include means for transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE, means for obtaining a second message that indicates a modified value of at least one parameter of the first subset of one or more parameters, and means for transmitting a third message that indicates feedback based on the second message.

A non-transitory computer-readable medium storing code for wireless communication is described. The code may include instructions executable by one or more processors to transmit, to a UE, a first message that indicates a configuration including a set of parameters, where the set of parameters includes a first subset of one or more parameters and a second subset of one or more parameters, where one or more parameters of the first subset of one or more parameters are modifiable by the UE, obtain a second message that indicates a modified value of at least one parameter of the first subset of one or more parameters, and transmit a third message that indicates feedback based on the second message.

Some examples of the method, network entities, and non-transitory computer-readable medium described herein may further include operations, features, means, or instructions for identifying the one or more parameters of the first subset of one or more parameters that may be modifiable by the UE based on the configuration.

In some examples of the method, network entities, and non-transitory computer-readable medium described herein, the feedback indicates an acceptance or a rejection of the modified value of the at least one parameter.

In some examples of the method, network entities, and non-transitory computer-readable medium described herein, the first message includes at least one of an RRC setup message, an RRC setup complete message, or an RRC reconfiguration message and the third message includes at least one of an RRC setup complete message, an RRC reject message, an RRC release message, or an RRC reconfiguration complete message.

Some examples of the method, network entities, and non-transitory computer-readable medium described herein may further include operations, features, means, or instructions for validating the modified value of the at least one parameter and generating the third message based on validating the modified value of the at least one parameter.

Some examples of the method, network entities, and non-transitory computer-readable medium described herein may further include operations, features, means, or instructions for obtaining a report including capability information that indicates whether the UE supports a learning model for reconfiguration of the one or more parameters of the first subset of one or more parameters.

In some examples of the method, network entities, and non-transitory computer-readable medium described herein, the modified value of the at least one parameter may be associated with an IE, a set of IEs, a carrier, or a set of carriers, or any combination thereof.

In some examples of the method, network entities, and non-transitory computer-readable medium described herein, the modified value of the at least one parameter corresponds to a removal of a carrier.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support user equipment (UE)-assisted reconfigurations in accordance with one or more aspects of the present disclosure.

FIGS. 3 and 4 show examples of process flows that support UE-assisted reconfigurations in accordance with one or more aspects of the present disclosure.

FIG. 5 shows an example of a machine learning (ML) architecture that supports UE-assisted reconfigurations in accordance with one or more aspects of the present disclosure.

FIGS. 6 and 7 show block diagrams of devices that support UE-assisted reconfigurations in accordance with one or more aspects of the present disclosure.

FIG. 8 shows a block diagram of a communications manager that supports UE-assisted reconfigurations in accordance with one or more aspects of the present disclosure.

FIG. 9 shows a diagram of a system including a device that supports UE-assisted reconfigurations in accordance with one or more aspects of the present disclosure.

FIGS. 10 and 11 show block diagrams of devices that support UE-assisted reconfigurations in accordance with one or more aspects of the present disclosure.

FIG. 12 shows a block diagram of a communications manager that supports UE-assisted reconfigurations in accordance with one or more aspects of the present disclosure.

FIG. 13 shows a diagram of a system including a device that supports UE-assisted reconfigurations in accordance with one or more aspects of the present disclosure.

FIGS. 14 through 17 show flowcharts illustrating methods that support UE-assisted reconfigurations in accordance with one or more aspects of the present disclosure.

### DETAILED DESCRIPTION

In some wireless communications systems, a network entity may transmit a configuration for a user equipment (UE) (e.g., a radio resource control (RRC) setup message, RRC reconfiguration message, RRC resume message, or another type of configuration message). In some examples, a network configuration may result in one or more validation failures at the UE side, which may cause the UE to trigger a radio link failure (RLF) or reestablishment procedure with the network entity. A reestablishment procedure with the network entity may involve a relatively long time and cause high interruptions to UE voice and data resumption. These validation failures may be due to various reasons, such as mandatory parameters being absent (e.g., missing) from the configuration, the network entity not following one or more conditional clauses as defined in one or more standards, invalid configurations not in line with one or more capabilities of the UE, battery limitations at the UE, thermal limitations at the UE, resource constraints, other failure reasons, or a combination thereof. It may be desirable for devices in the wireless communications system to avoid RLFs and stay connected despite minor, recoverable misconfigurations. For example, it may be desirable to avoid declaring an RLF for recoverable misconfigurations and provide users with improved cellular connectivity and uninterrupted data transfers.

In some implementations, a UE may receive, from a network entity, a first message that indicates a configuration including a set of parameters. The set of parameters may include a first subset of one or more parameters and a second subset of one or more parameters, where one or more parameters of the first subset are modifiable by the UE. In some examples, the UE may modify a value of at least one parameter of the first subset based on a capability of the UE, a condition at the UE, or a combination thereof. For example, the UE may release an information element (IE) corresponding to the at least one parameter, may set at least one missing IE to a default value, may overwrite the value of the at least one parameter based on the at least one parameter being unsupported by the capability of the UE, may set the value of the at least one parameter to a value selected from a set of allowed values based on a performance metric of the UE or a quality of service (QoS) metric, may enable support for the at least one parameter, or a combination thereof. The UE may transmit a second message that indicates the modified value of the at least one parameter. In response, the network entity may transmit, to the UE, a third message that indicates feedback based on the second message (e.g., indicating whether the modified value of the at least one parameter is accepted or rejected by the network entity).

Particular aspects of the subject matter described herein may be implemented to realize one or more potential advantages. The described techniques may provide for improved communication reliability, reduced latency, reduced processing, improved user experience related to reduced processing, reduced power consumption, more efficient utilization of communication resources, improved coordination between devices, and longer battery life. For example, rather than dropping the connection between the UE and the network entity in response to a recoverable misconfiguration, the UE may fix the misconfiguration by transmitting a modified value of one or more parameters. Significant time and resources may be saved by avoiding a reestablishment procedure.

Aspects of the disclosure are initially described in the context of wireless communications systems. Aspects of the disclosure are then described in the context of process flows and a machine learning (ML) architecture. Aspects of the disclosure are further illustrated by and described with reference to apparatus diagrams, system diagrams, and flowcharts that relate to UE-assisted reconfigurations.

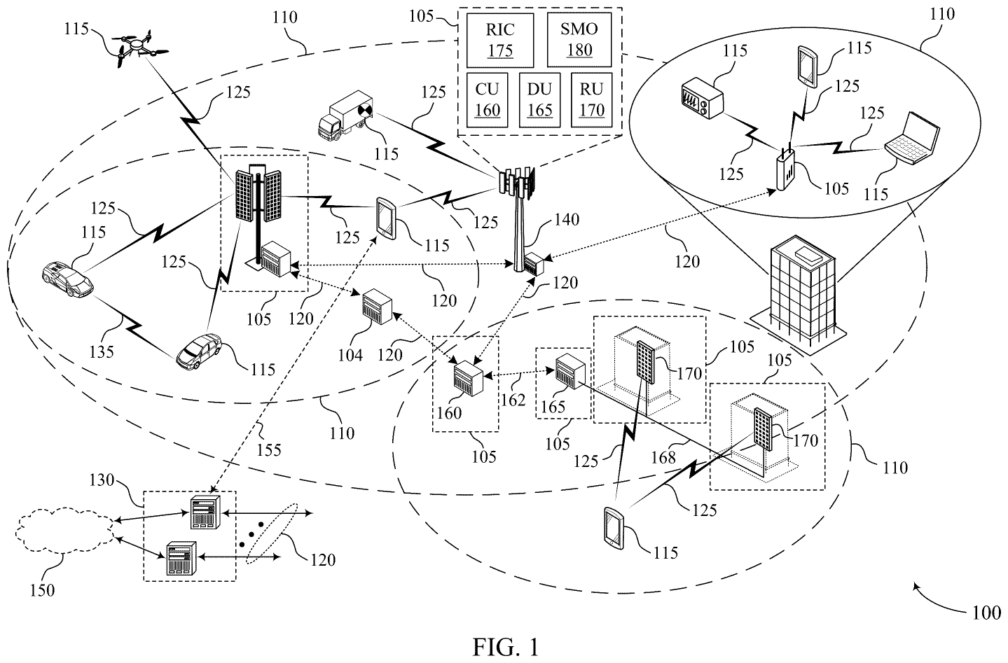

FIG. 1 shows an example of a wireless communications system 100 that supports UE-assisted reconfigurations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δf ₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Certain aspects and techniques as described herein may be implemented, at least in part, using an artificial intelligence (AI) program, such as a program that includes an ML or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform identification of one or more parameters that belong to a first subset of modifiable parameters, modification of the value of one or more parameters belonging to the first subset of modifiable parameters, or both. Thus, during operation of a device, the ML model may receive input data (such as channel quality measurements, a quantity and content of one or more feedback messages associated with one or more modified parameters, one or more capabilities of a UE 115, one or more conditions at the UE 115, or a combination thereof and make inferences (such as the modified value of the one or more parameters) based on the weights and biases.

ML models may be deployed in one or more devices (for example, network entities and UEs (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models in UE-assisted reconfigurations. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In the wireless communications system 100, a network entity 105 may transmit a configuration for a UE (e.g., an RRC setup message, RRC reconfiguration message, RRC resume message, or another type of configuration message) via a communication link 125. In some examples, a network configuration may result in one or more validation failures at the UE 115, which may cause the UE 115 to trigger an RLF or reestablishment procedure with the network entity 105. A reestablishment procedure with the network entity 105 may involve a relatively long time and cause high interruptions to voice and data resumption at the UE 115. These validation failures may be due to various reasons, such as mandatory parameters being absent (e.g., missing) from the configuration, the network entity 105 not following one or more conditional clauses as defined in one or more standards, invalid configurations not in line with one or more capabilities of the UE 115, battery limitations at the UE 115, thermal limitations at the UE 115, resource constraints, other failure reasons, or a combination thereof. It may be desirable for devices in the wireless communications system 100 to avoid RLFs and stay connected despite relatively minor, recoverable misconfigurations. For example, it may be desirable to avoid declaring an RLF for recoverable misconfigurations and provide users with improved cellular connectivity and uninterrupted data transfers.

In some implementations, a UE 115 may receive, from a network entity 105 via a communication link 125, a first message that indicates a configuration including a set of parameters. The set of parameters may include a first subset of one or more parameters and a second subset of one or more parameters, where one or more parameters of the first subset are modifiable by the UE 115. In some examples, the UE 115 may modify a value of at least one parameter of the first subset based on a capability of the UE 115, a condition at the UE 115, or a combination thereof. For example, the UE 115 may release an IE corresponding to the at least one parameter, may set at least one missing IE to a default value, may overwrite the value of the at least one parameter based on the at least one parameter being unsupported by the capability of the UE 115, may set the value of the at least one parameter to a value selected from a set of allowed values based on a performance metric of the UE 115 or a QoS metric, may enable support for the at least one parameter, or a combination thereof. Releasing an IE may include clearing, erasing, resetting, or otherwise changing a value in a field associated with a configuration (e.g., indicated by the configuration message 210). The UE 115 may transmit a second message that indicates the modified value of the at least one parameter. In response, the network entity 105 may transmit, to the UE 115, a third message that indicates feedback based on the second message (e.g., indicating whether the modified value of the at least one parameter is accepted or rejected by the network entity 105).

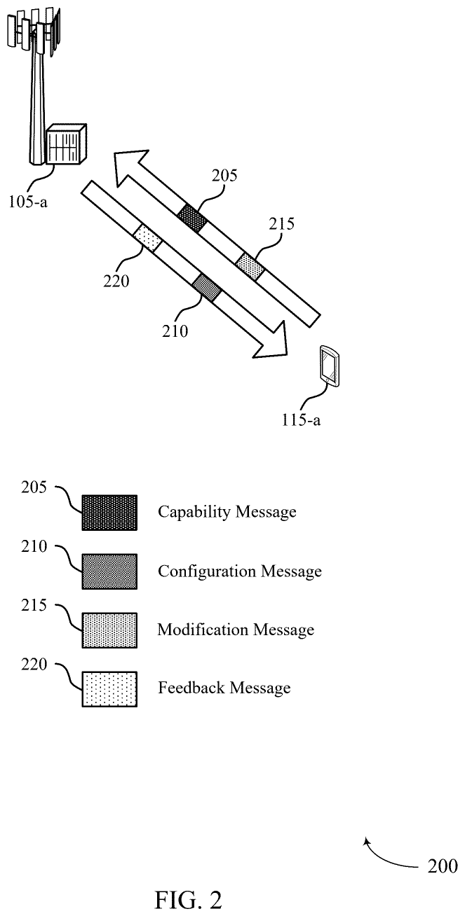

FIG. 2 shows an example of a wireless communications system 200 that supports UE-assisted reconfigurations in accordance with one or more aspects of the present disclosure. In some examples, the wireless communications system 200 may implement aspects of the wireless communications system 100. For example, the wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115 and a network entity 105, it is understood that the described techniques may be performed by a wireless device different from a UE 115 and a network entity 105. As described herein, operations performed by the UE 115-a and the network entity 105-a may be respectively performed by a UE 115, a network entity 105, or another wireless device, and the examples shown should not be construed as limiting.

The network entity 105-a may transmit, to the UE 115-a, a configuration message. For example, after the UE 115-a transitions from an idle state or idle mode to a connected state or connected mode, the network entity 105-a may transmit an RRC setup configuration via the configuration message 210. In another example, once the network entity 105-a is aware of one or more capabilities of the UE 115-a (e.g., via the capability message 205), the network entity 105-a may transmit an RRC reconfiguration message via the configuration message 210. In a third example, after the UE transitions out of an RRC inactive state, the network entity 105-a may transmit an RRC resume configuration via the configuration message 210. In some cases, a network configuration (e.g., RRC setup, RRC reconfiguration, RRC resume, or another type of configuration) may result in one or more validation failures at the UE side. That is, the UE 115-a may be unable to apply part or all of the configuration from the configuration message 210 because at least one parameter of the configuration is inaccurate, does not match an expectation of the UE 115-a, does not match a capability of the UE 115-a, is not appropriate for one or more conditions at the UE 115-a, or a combination thereof.

A validation failure may cause the UE 115-a to trigger an RLF or reestablishment procedure with the network entity 105-a. In an RLF scenario, the UE 115-a may erase the configuration and initiate a fresh connection with the network entity 105-a through a reestablishment procedure. A reestablishment procedure with the network entity 105-a may involve a relatively long time (e.g., hundreds of milliseconds) and cause high interruptions to UE voice and data resumption. These validation failures may be due to various reasons, such as mandatory parameters being absent (e.g., missing) from the configuration, the network entity 105-a not following one or more conditional clauses as defined in standards, invalid configurations not in line with one or more capabilities of the UE 115-a, battery limitations at the UE 115-a, thermal limitations at the UE 115-a, resource constraints (e.g., due to baseband resource applications, when the UE 115-a is indoors or in a closed network such as an office environment, or when the UE 115-a prefers a first technology over a second technology), other failure reasons, or a combination thereof.

In some cases, the configuration message 210 may result in a validation failure at the UE 115-a due to conditions at the UE 115-a, even if the configuration is otherwise accurate. For example, the configuration message 210 may be a multi-carrier reconfiguration (e.g., adding eight component carriers (CCs) or five CCs), and if the UE thermal conditions are high (e.g., high-temperature scenario) or if the UE batter percentage is low, the UE 115-a may be unable to exercise the configuration from the network entity 105-a. Configuration validation failures may contribute to a significant quantity of RLFs in the field across many carriers. For example, 20-25% of RLFs may be due to reconfiguration validation failures (e.g., rather than a SIB read failure, a random access channel (RACH) problem, a layer 2 (L2) radio link (RL) failure, or another type of failure).

In some cases, in response to receiving the configuration message 210, the UE 115-a may either accept the full configuration (e.g., including all parameters), or the UE 115-a may reject the full configuration and initiate a reestablishment procedure (e.g., if even one parameter is misconfigured). For RLF, a reestablishment procedure may take hundreds of milliseconds for the UE 115-a to get back in sync with the network entity 105-a, and the network entity 105-a may reconfigure all physical parameters from scratch. In addition to using valuable time for such reestablishment, a RLF may result in a relatively large amount of additional processing. In some examples, there may be no way to immediately indicate from the UE 115-a to the network entity 105-a which configuration led to an RLF, which may result in a series of reconfigurations (e.g., ping-pong reconfigs-RLFs), loss of service (e.g., 5G or 4G service), and the cell being barred. Many misconfigurations also result in continuous network meetings to explain the issue, and it may take weeks for a network to update based on the misconfiguration.

It may be desirable for the devices in the wireless communications system 200 to avoid RLFs and stay connected, despite minor (e.g., recoverable) misconfigurations, which may be frequent in field deployments. For example, devices in the wireless communications system 200 may declare an RLF for an unrecoverable misconfiguration and refrain from declaring an RLF for a recoverable misconfiguration. By implementing one or more aspects of the present disclosure, the UE 115-a and the network entity 105-a may provide users with an improved cellular connectivity experience and relatively un-interrupted data transfers (e.g., during a voice call, a data call, or a browser session).

Aspects of the present disclosure may define new ways to send back a UE-proposed reconfiguration to the network entity 105-a by modifying (e.g., fixing, adjusting, updating) one or more relevant parameters (e.g., IEs, configurations, child parameters, parent parameters) that may be incorrectly configured. For example, the UE 115-a may transmit, and the network entity 105-a may receive, a capability message 205 (e.g., a report) indicating that the UE 115-a is capable of modifying one or more parameters of a configuration. In some examples, the capability message 205 may indicate whether the UE 115-a supports a learning model for reconfiguration of the one or more parameters.

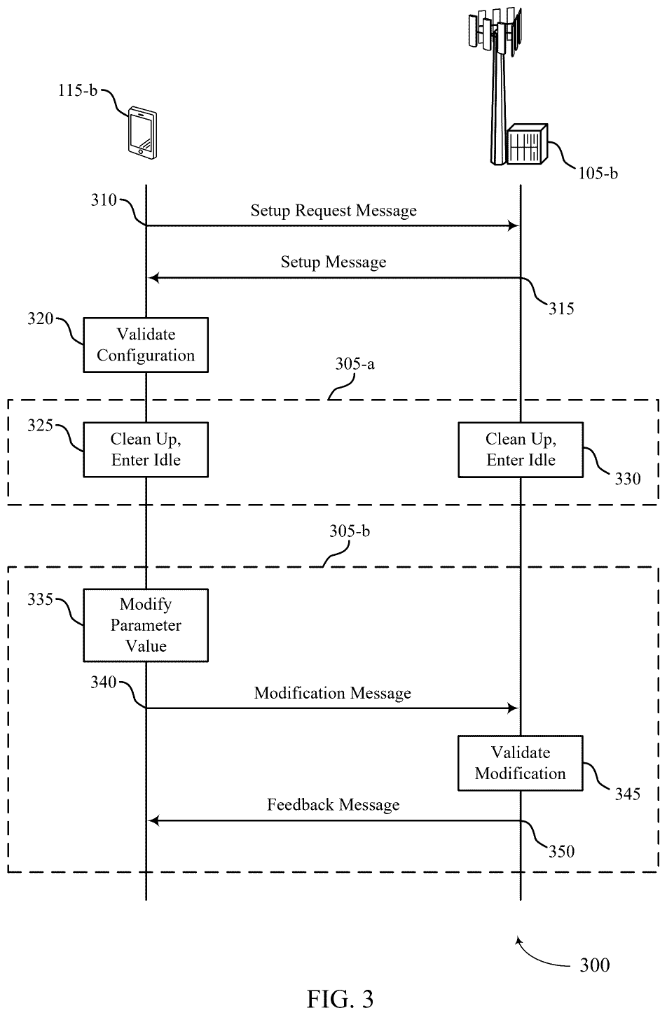

The network entity 105-a may transmit, and the UE 115-a may receive, a configuration message 210. In some examples (e.g., in a UE-driven RRC setup procedure in which the UE 115-a transitions from an idle state to a connected state), network entity 105-a may transmit the configuration message 210 in response to obtaining a configuration request message (e.g., a setup request message, such as an RRC setup request message). In such cases, the configuration message 210 may be an RRC setup message including one or more network configuration parameters (e.g., as described in more detail with reference to FIG. 3). Additionally, or alternatively, the configuration message 210 may be an RRC reconfiguration message including network configuration parameters (e.g., after the network entity 105-a is aware of UE capability, such as via the capability message 205). In either case, the configuration message 210 may include a set of parameters that includes a first subset of one or more parameters and a second subset of one or more parameters. One or more parameters of the first subset of one or more parameters may be modifiable (e.g., recoverable) by the UE 115-a. In some examples, the UE 115-a may have the intelligence to determine (e.g., identify) which parameters may be altered (e.g., which parameters of the set of parameters are included in the first subset of one or more parameters that are modifiable by the UE 115-a).

In some examples, one or more standards (e.g., a wireless communication standard) may define which parameters may be modified (e.g., recovered, assisted) by the UE 115-a and which parameters or configurations may not be altered so that the UE 115-a and the network entity 105-a may be in sync and not get out of sync. For example, a standard may define a DRX configuration (also referred to as drx-config), an RLC configuration (also referred to as rlc-config), a PDCP configuration (also referred to as pdcp-config), RLF/MEAS timers and periodicity, other configurations, or a combination thereof as recoverable configurations and may define a TDD UL/DL pattern configuration (also referred to as tdd-UL-DL-ConfigurationDedicated), a RACH configuration (also referred to as Rach-config), a grant configuration (also referred to as ConfiguredGrantConfig), a bandwidth configuration (e.g., channelBW), other configurations, or a combination thereof as non-recoverable. A tag may indicate whether a parameter or configuration is recoverable or non-recoverable by the UE 115-a. In some examples, the UE 115-a may identify the first subset of one or more modifiable parameters based on a special code in the autonomous system number (ASN) associated with each recoverable parameter (e.g., IE, configuration). The special code may indicate, to the UE 115-a, that the field may be modified by the UE 115-a in case of a misconfiguration.

In some examples, the UE 115-a may validate the network-provided configuration (e.g., the configuration message 210). When the validation fails (e.g., the UE 115-a determines that one or more parameters of the network-provided configuration are invalid, incorrect, or unsupported), the UE 115-a may have at least two options. In a first option, where the one or more invalid parameters are non-modifiable (e.g., belong to the second subset of one or more parameters), the UE 115-a may clean up the configuration associated with the configuration message 210 (e.g., remove, delete, or erase one or more physical parameters associated with the configuration), enter an idle mode, and retransmit a setup request message. The network entity 105-a may wait for a period of time (e.g., by setting a timer T300, or by waiting a quantity of milliseconds) for a reply from the UE 115-a before cleaning up the configuration and entering an idle mode. In this case, the network entity 105-a may be unaware of which parameter (e.g., IE, configuration) cased the failure. Additionally, or alternatively, if the configuration message 210 was a reconfiguration message, the first option may involve the UE 115-a cleaning up one or more physical parameters, performing a MAC reset, performing an acquisition (e.g., acquisition plus RACH (ACQ+RACH)), transmitting a reestablishment request (e.g., RRC reestablishment request), and getting back in sync with the network entity 105-a (e.g., potentially taking hundreds of milliseconds or one or more seconds).

In some implementations of a second option, where one or more invalid parameters of the configuration message 210 (e.g., one or more parameters of the first subset of one or more parameters) are modifiable by the UE 115-a, the UE 115-a may modify a value of the one or more invalid parameters of the configuration message 210 (e.g., fix all incorrect parameters) based one or more capabilities of the UE 115-a (e.g., a quantity of resources available), based on a set of one or more conditions at the UE 115-a (e.g., thermal conditions, battery conditions), or based on a combination thereof.

There are multiple ways (e.g., categories, types, methods) in which the UE 115-a may modify the one or more parameters in response to a network misconfiguration. In a first modification category, the UE 115-a may modify the value of one or more parameters by releasing at least one IE of a set of one or more IEs (e.g., an immediate parent IE), where at least one IE corresponds to the one or more parameters. In some cases, RRC over the air (OTA) validation failure, a common secondary cell (SCell) configuration parameter (e.g., SCellConfigCommon) may not be included with SCell modification, and the UE 115-a may release an immediate parent or a possible parent of the common SCell configuration parameter. The UE 115-a may disregard the common SCell configuration parameter and apply the modification. The first modification type may be extended to component carrier (CC) release (Rel), BWP Rel, sounding reference signal (SRS) Rel, channel state information (CSI) Rel, another type of Rel, or a combination thereof.

In a second modification category, the UE 115-a may modify the value of one or more parameters by setting at least one missing IE of the set of one or more IEs to a default value, where the at least one missing IE corresponds to the one or more parameters. For example, for a low-latency communications data bearer (LLCDB): RRC OTA validation failure, a common search space list extension parameter (e.g., commonSearchSpaceListExt_r16) may be present without a common search space list parameter (e.g., commonSearchSpaceList). In response, the UE 115-a may set a default value for the missing IE (e.g., an IE associated with commonSearchSpaceList), overwrite present flags (e.g., Release 15 (R15) present flags), or both.

In a third modification category, the UE 115-a may modify the value of one or more parameters by deriving (e.g., backtracking) the value of one or more missing (e.g., mandatory) parameters based on one or more configurations (e.g., the configuration message 210). For example, for an LLCDB: RRC OTA validation failure, a served radio bearer parameter (e.g., ServedRadioBearer) may not be present for a new logical channel (LC) identifier (ID) setup (e.g., LC ID 0). In response, the UE 115-a may derive the value of the served radio bearer parameter based on a resource block (RB) ID, an LC ID, radio link control (RLC), or another method.

In a fourth modification category, the UE 115-a may modify the value of one or more parameters by overwriting the value of the one or more parameters based on the one or more parameters being unsupported by the one or more capabilities of the UE 115-a. That is, the UE may overwrite unsupported capability features or configurations to supported capabilities or configurations. If no fallback is possible, the UE 115-a may release the configuration from the configuration message 210.

In a first example of the fourth modification category, the network entity 105-a may configure, via the configuration message 210, a 30 MHz carrier bandwidth for n66, which the UE 115-a may not support. The UE 115-a may have indicated (e.g., advertised, via the capability message 205) a supported downlink bandwidth (a parameter supportedBandwidthDL) of 20 MHz, 40 MHz, or 50 MHz. Instead of triggering an RLF and camping issues, for relatively lower bandwidths, the UE 115-a may modify the carrier bandwidth to the supported 20 MHz (as long as the active BWP bandwidth is within it) and report the modified bandwidth to the network entity 105-a via the modification message 215. If the UE 115-a supports relatively higher bandwidths, the UE 115-a may modify the carrier bandwidth to an aggregated BWP bandwidth (e.g., such that the aggregated BWP bandwidth is less than or equal to the carrier bandwidth), and may report the modified carrier bandwidth to the network entity 105-a via the modification message 215.

In a second example of the fourth modification category, for an LLCDB: RRC OTA validation failure, the network entity 105-a may include a parameter in the configuration message 210 that the UE 115-a does not support. For example, the network entity 105-a may include a dynamic switch type parameter (e.g., dynamic_switch_ra_type0_1_pusch) in the configuration message 210, and the UE 115-a might not support the included dynamic switch type parameter. In response, the UE 115-a may overwrite a second parameter (e.g., pdsch_cfg_ded_ptr, u.setup, resourceAllocation) to either Type 0 or Type 1, instead of making a dynamic switch.

In a third example of the fourth modification category, for an LLCDB: RRC OTA validation failure, the network entity 105-a may include an inter-slot frequency hopping parameter (e.g., inter_slot_freq_hopping_pusch) in the configuration message 210, but UE 115-a may not support the included inter-slot frequency hopping parameter. In response, the UE 115-a may release a more general frequency hopping parameter (e.g., ota_pusch_cfg_ptr, u.setup, frequencyHopping) altogether, since neither intra-slot hopping nor inter-slot hopping capability may be supported by the UE 115-a.

In a fourth example of the fourth modification category, the network entity 105-a may configure, via the configuration message 210, a single input, single output (SISO) parameter, but the UE 115-a may be capable of MIMO. The UE 115-a may modify the parameter from SISO to MIMO for a particular band combination. In some examples, the UE 115-a may enhance a capability, downgrade a capability, remove a capability, or a combination thereof to be in sync with the network entity 105-a.

In a fifth modification category, the UE 115-a may modify the value of one or more parameters by setting the value of the one or more parameters to a selected from one or more allowed (e.g., valid) values based on a performance metric of the UE 115-a and one or more QoS metrics (e.g., rather than based on a capability of the UE 115-a, as in the fourth medication category). For example, for an LLCDB: RRC OTA validation failure, the value of a scaling factor parameter (e.g., scalingFactorBI) may be out of a range of allowed values (e.g., invalid due to specification limits). In response, the UE 115-a may set the value of the scaling factor parameter to an allowed value as per a specification and based on a UE algorithm for performance and QoS.

In a sixth modification category, the UE 115-a may modify the value of one or more parameters by enabling support for the one or more parameters based on the one or more capabilities of the UE 115-a, where at least one capability of the one or more capabilities indicates at least one of a supported carrier or a supported public land mobile network (PLMN). For example, a conditional handover (CHO) may not be configured by the network entity 105-a via the configuration message 210, but the UE 115-a may know, per priori finger-printed knowledge, that the network entity 105-a, PLMN, or cell global identity (CGI) may support CHO. Thus, the UE 115-a may configure the CHO configuration parameters based on the prior knowledge and transmit an indication of the CHO configuration parameters to the network entity 105-a via the modification message 215 to help the network entity 105-a prepare the target cells and configure the target cells. This may result in faster handovers and reduced data interruptions. Similar UE-assisted features may be enabled for uplink MIMO, discontinuous reception (DRX), beam failure recovery (BFR), SRS, supplementary uplink (SUL), SCell additions, and other applications that may provide improved connectivity and performance for the UE 115-a.

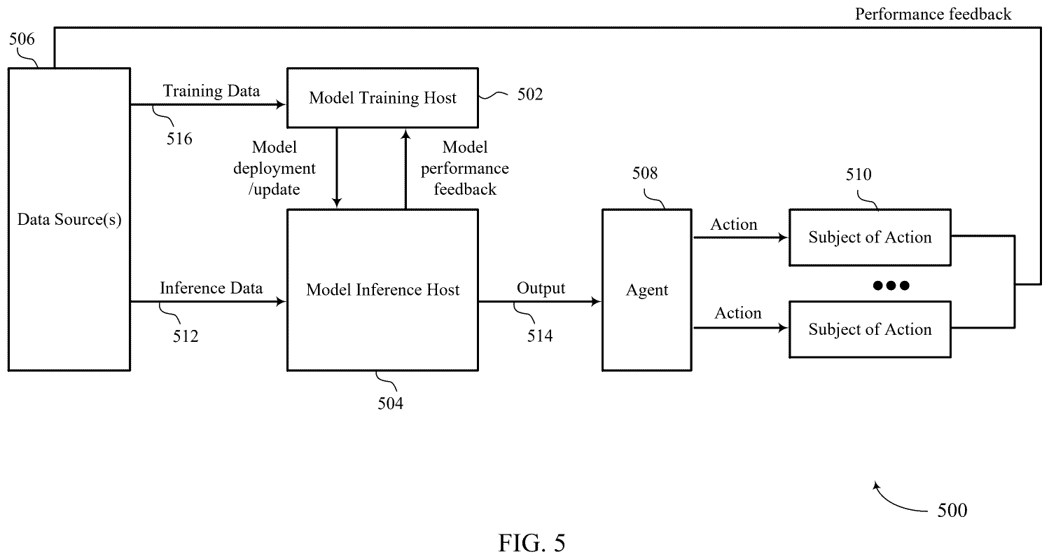

In some examples, the UE 115-a may modify one or more parameter values in accordance with the first modification category, in accordance with the second modification category, in accordance with the third modification category, in accordance with the fourth modification category, in accordance with the fifth modification category, in accordance with the sixth modification category, in accordance with another modification category, or a combination thereof. In some examples, the UE 115-a may modify the value of the one or more parameters based on a learning model, as described in more detail with reference to FIG. 5. The modification of the network configuration may be within an IE, across multiple IEs, within a carrier, across multiple carriers, or a deletion of a complete carrier (e.g., deletion of a secondary cell (SCell)).

The UE 115-a may transmit, to the network entity 105-a, a modification message 215 (e.g., a UE-proposed configuration) that may indicate the modified value of the one or more parameters of the first subset of modifiable parameters. For example, the modification message 215 may be an uplink dedicated control channel (UL-DCCH) (e.g., a reverse RRC reconfiguration message or RRC reconfiguration complete message) with one or more UE-updated configurations (e.g., RRC reconfiguration OCTET string).

In some examples, the network entity 105-a may validate the UE-provided configuration (e.g., the modified value of the one or more parameters, the UE-assisted configuration, the UE-modified configuration). The network entity 105-a may transmit, to the UE 115-a, a feedback message 220 based on whether or not the validation of the one or more modified parameters failed at the network entity 105-a. If the validation succeeded, the network entity 105-a may transmit, via the feedback message 220, an indication that the network entity 105-a accepts the UE-driven configuration (e.g., the modified value of the one or more parameters). For example, the feedback message 220 may be a downlink dedicated control channel (DL-DCCH) (e.g., a reverse RRC reconfiguration complete message, a success message, a complete message, an acknowledgment (ACK) message). In this case (e.g., when the modified configuration is accepted), the UE may remain in a connected state. The UE 115-a and the network entity 105-a may operate in accordance with the UE-driven configuration (e.g., in accordance with the modified value of the one or more parameters).

If the validation at the network entity 105-a failed, the network entity 105-a may transmit, via the feedback message 220, an indication that the network entity 105-a rejects the UE-driven configuration (e.g., the modified value of the one or more parameters). For example, the feedback message 220 may be a DL-DCCH (e.g., an RRC reject message, an RRC release message, or another reject message or release message). In some examples, if the feedback message indicates a validation failure (e.g., the network entity 105-a rejects the modified value of the one or more parameters), the UE 115-a and the network entity 105-a may perform one or more steps associated with option 1 (e.g., as if the one or more invalid parameters were non-modifiable). That is, if the network entity 105-a transmits a negative acknowledgment (NACK) in the feedback message 220 (e.g., the feedback message 220 is an RRC release message), the UE 115-a may clean up and return to an idle state, or transmit an RRC reestablishment request message to attempt to reconnect with the network entity 105-a. In some cases, the feedback message 220 may be a fallback message instructing the UE 115-a to release all prior configurations and apply a fallback configuration provided in an RRC setup message.

In some examples, a learning model at the UE 115-a may learn which parameters belong in the first subset of one or more parameters (e.g., modifiable parameters) and which parameters belong in the second subset of one or more parameters (e.g., non-modifiable parameters) by observing one or more feedback messages 220 over time. For example, if a first parameter A is originally included in the first subset of one or more parameters, the UE 115-a modifies the value of the first parameter A multiple times (e.g., via multiple modification messages 215), and the UE 115-a receives multiple feedback messages 220 indicating that the network entity 105-a rejects the modification messages 215 associated with the first parameter A, the learning model may indicate, to the UE 115-a, that the first parameter A may belong to the second subset of one or more parameters (e.g., non-modifiable parameters).

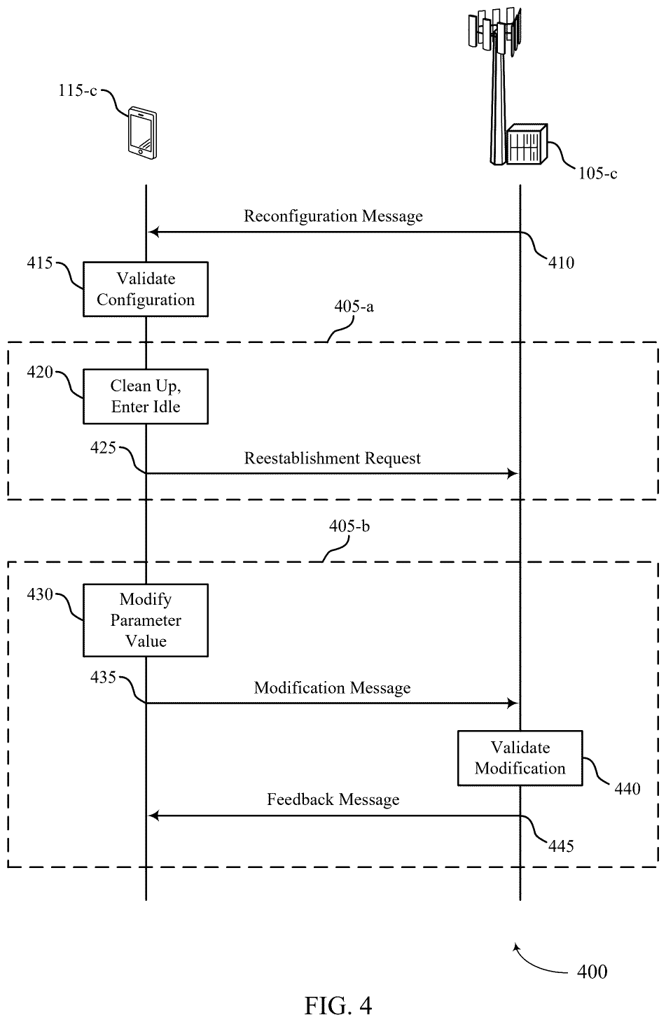

FIG. 3 shows an example of a process flow 300 that supports UE-assisted reconfigurations in accordance with one or more aspects of the present disclosure. In some examples, the process flow 300 may be implemented by, or may implement aspects of, the wireless communications systems 100 and 200. For example, the process flow 300 includes a network entity 105-b and a UE 115-b, which may be examples of the corresponding devices described with reference to FIGS. 1 and 2. Following the process flow 300, the UE 115-b may modify the value of one or more parameters included in a configuration from the network entity 105-b. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices. The process flow 300 may be implemented in cases where the network entity 105-b transmits an RRC setup message, while the process flow 400 described with reference to FIG. 4 may be implemented in cases where the network entity 105-c transmits an RRC reestablishment message. Similar process flows may exist for cases where a network entity 105 transmits an RRC resume message, though such a process flow is not depicted in the present disclosure.

At 310, the UE 115-b may transmit (e.g., output), and the network entity 105-b may obtain (e.g., receive), a setup request message (e.g., an RRC setup request message, to initiate a call). For example, the UE 115-b may transmit the setup request message as part of transitioning from an idle mode to a connected mode. Based on receiving the setup request message, the network entity 105-b may know that the UE 115-b is attempting to establish a call based on a cell radio network temporary identifier (C-RNTI). In some examples, the UE 115-b may transmit, and the network entity 105-b may obtain (e.g., as part of the setup request message, or as a separate capability message), a report including capability information that indicates whether the UE 115-b supports a learning model for reconfiguration of one or more parameters received from the network entity 105-b (e.g., one or more parameters of a first subset of one or more parameters that are modifiable by the UE 115-b).

At 315, the network entity 105-b may transmit, and the UE 115-b may receive, a first message (e.g., a setup message, such as an RRC setup message including network configuration parameters) that indicates a configuration including a set of parameters. For example, the configuration may allow the UE 115-b to enter a connected mode. The set of parameters may include a first subset of one or more parameters and a second subset of one or more parameters. The one or more parameters of the second subset of one or more parameters may be modifiable by the UE 115-b. In some examples, the setup message may include (e.g., may be) at least one of an RRC setup message, an RRC setup complete message, or an RRC reconfiguration message (e.g., as discussed with reference to FIG. 4). In some examples, at least one parameter of the first subset of one or more parameters may lead to a validation failure (e.g., if the network entity 105-b was unaware of one or more capabilities of the UE 115-b or one or more conditions at the UE 115-b).

At 320, the UE 115-b may identify the one or more parameters of the first subset of one or more parameters that are modifiable by the UE 115-b based on the configuration (e.g., the setup message, the RRC setup message) received at 315. In some examples, the UE 115-b may identify the one or more parameters of the first subset of one or more parameters that are modifiable by the UE 115-b based on a standard. In some examples, the UE 115-b may validate or fail to validate the one or more parameters of the first subset of one or more parameters. For example, the UE 115-b may evaluate the set of parameters associated with the configuration from the network entity 105-b to determine if the configuration is valid based on one or more capabilities of the UE 115-b, based on one or more conditions at the UE 115-b, or a combination thereof.

In response to a validation failure at 320, the UE 115-b may have at least two options: a first option 305-a and a second option 305-b. The UE 115-b may perform the first option 305-a when a validation failure occurs at 320 and the one or more parameters that cause the validation failure are non-modifiable (e.g., non-recoverable, belonging to the second subset of one or more parameters) by the UE 115-b. The UE 115-b may perform the second option 305-b when a validation failure occurs at 320 and the one or more parameters that cause the validation failure are modifiable (e.g., recoverable, belonging to the first subset of one or more parameters) by the UE 115-b. In some examples, if the network entity 105-b rejects a modified value of one or more parameters by the UE 115-b, the UE 115-b may revert back to the first option 305-a at 325.

At 325, as part of the first option 305-a, the UE 115-b may clean up the configuration (e.g., delete, erase, or remove the configuration received at 315) and release the connection to the network entity 105-b. The UE 115-b may enter an idle mode and may loop back to step 310 (e.g., retransmit the setup request message).

At 330, as part of the first option 305-a, the network entity 105-b may wait for a period of time (e.g., by setting a timer T300, or by waiting a quantity of milliseconds) for a response from the UE 115-b. If the network entity 105-b has not received a response (e.g., a setup complete message, RRC setup complete) by the end of the time period, the network entity 105-b may assume an RLF and may also clean up the configuration (e.g., delete, erase, or remove the configuration transmitted at 315). The network entity 105-b may be unaware of which parameter or parameters (e.g., IEs or configurations) in the setup message at 315 caused the failure.

At 335, as part of the second option 305-b, the UE 115-b may modify a value of at least one parameter based on a set of one or more capabilities of the UE 115-b, based on a set of one or more conditions at the UE 115-b, or a combination thereof. In some examples, the UE 115-b may modify the values of multiple parameters of the first subset of one or more parameters. In some examples, the UE 115-b may modify the value of the at least one parameter based on a validation failure of the one or more parameters of the first subset of one or more parameters at 320. In some examples, the UE 115-b may modify the value of the at least on parameter based on a learning model (e.g., an algorithm), as described in more detail with reference to FIG. 5.

There may be many ways in which the UE 115-b may modify (e.g., change, fix, correct) the value of the at least one parameter, and the examples described herein should not be construed as limiting. In some examples, the UE 115-b may modify the value of the at least one parameter by releasing at least one IE of a set of one or more IEs, where the at least one IE may correspond to the at least one parameter. Additionally, or alternatively, the UE 115-b may modify the value of the at least one parameter by setting at least one missing IE of the set of one or more IEs to a default value, where the at least one missing IE may correspond to the at least one parameter. Additionally, or alternatively, the UE 115-b may modify the value of the at least one parameter by overwriting the value of the at least one parameter based on the at least one parameter being unsupported by the set of capabilities of the UE 115-b.

Additionally, or alternatively, the UE 115-b may modify the value of the at least one parameter by setting the value of the at least one parameter to a value selected from one or more allowed values based on a performance metric of the UE 115-b and one or more QoS metrics. Additionally, or alternatively, the UE 115-b may modify the value of the at least one parameter by enabling support for the at least one parameter based at least in part on the set of one or more capabilities of the UE 115-b, wherein at least one capability of the set of one or more capabilities indicates at least one of a supported carrier or a supported public land mobile network. Additionally, or alternatively, the modified value of the at least one parameter may be associated with an IE, a set of IEs, a carrier, or a set of carriers, or any combination thereof. For example, the UE 115-b may modify the value of the at least one parameter within an IE, across multiple IEs, within a carrier, or across multiple carriers. In some examples, the modified value of the at least one parameter may correspond to a removal of a carrier.

At 340, the UE 115-b may transmit, and the network entity 105-b may obtain, a second message (e.g., a modification message) that indicates the modified value of at least one parameter of the first subset of one or more parameters. For example, the modification message may be an UL-DCCH (reverse RRC setup) message or an UL-DCCH (RRC setup complete) message with one or more UE-updated configurations (e.g., RRC reconfiguration OCTET string including an indication of the modified value of the at least one parameter).

At 345, the network entity 105-b may validate the modified value of the at least one parameter. That is, the network entity 105-b may determine if the network entity 105-a is in a position to apply the modified value of the at least one parameter. In some examples, this may be based on whether the modified value meets a threshold, whether the modified value conflicts with other parameter values, and/or other criteria applied at the network entity 105-b. Based on the result of the validation at 345, the network entity 105-b may transmit a feedback message at 350.

At 350, the network entity 105-b may transmit, and the UE 115-b may receive, a third message (e.g., a feedback message) that indicates feedback based at least in part on the second message indicating the modified value or values at 340. In some examples, the feedback may indicate an acceptance or rejection of the modified value of the at least one parameter. If the modification was successfully validated by the network entity 105-b at 345, the feedback may indicate an acceptance (e.g., an ACK, DL-DCCH (Reverse RRCSetupComplete)), and the UE 115-b may successfully connect to the network entity 105-b (e.g., avoiding a time-intensive RLF and reestablishment procedure). If the modification validation failed at 345, the feedback may indicate a rejection (e.g., a NACK, DL-DCCH (RRC reject, RRC release)), and the UE 115-b may perform one or more actions associated with the first option 305-a (e.g., cleaning up and entering an idle mode at 325, retransmitting a setup request message). In some examples, the feedback message may include at least one of an RRC setup complete message, an RRC reject message, an RRC release message, or an RRC reconfiguration complete message.

FIG. 4 shows an example of a process flow 400 that supports UE-assisted reconfigurations in accordance with one or more aspects of the present disclosure. In some examples, the process flow 400 may be implemented by, or may implement aspects of, the wireless communications systems 100 and 200. For example, the process flow 400 includes a network entity 105-c and a UE 115-c, which may be examples of the corresponding devices described with reference to FIGS. 1 and 2. Following the process flow 400, the UE 115-c may modify the value of one or more parameters included in a configuration from the network entity 105-c. Alternative examples of the following may be implemented, where some steps are performed in a different order than described or are not performed at all. In some cases, steps may include additional features not mentioned below, or further steps may be added. Although the UE 115-c and the network entity 105-c are shown performing the operations of the process flow 400, some aspects of some operations may also be performed by one or more other wireless devices. The process flow 400 may be implemented in cases where the network entity 105-c transmits an RRC reestablishment message, while the process flow 300 described with reference to FIG. 3 may be implemented in cases where the network entity 105-b transmits an RRC setup message. Similar process flows may exist for cases where a network entity 105 transmits an RRC resume message, though such a process flow is not depicted in the present disclosure.

In some examples, the UE 115-c may transmit, and the network entity 105-c may obtain (e.g., as part of the setup request message, or as a separate capability message), a report including capability information that indicates whether the UE 115-c supports a learning model for reconfiguration of one or more parameters received from the network entity 105-c (e.g., one or more parameters of a first subset of one or more parameters that are modifiable by the UE 115-c). In the process flow 400, the UE 115-c and the network entity 105-c may already be connected (e.g., setup was successful, the UE 115-c has exchanged security keys with the network entity 105-c, the UE 115-c has exchanged capability information with the network entity 105-c, or a combination thereof).

At 410, the network entity 105-c may transmit, and the UE 115-c may receive, a first message (e.g., a reconfiguration message, RRC reconfiguration) indicating a configuration that includes a set of parameters. The reconfiguration message may have a relatively large payload (e.g., including BWP configurations, SRS configurations, CSI configurations, carrier configurations, other configurations, or a combination thereof), particularly in 5G, and thus may encompass a significant number of parameters that could potentially be invalid. Additionally, one or more carrier configurations within the reconfiguration message may consume substantial battery and thermal power at the UE 115-c, potentially leading to conditions that increase the likelihood of validation failures. The set of parameters may consist of a first subset of one or more parameters and a second subset of one or more parameters. The one or more parameters within the second subset may be modifiable by the UE 115-c. In some instances, the reconfiguration message may include at least one of an RRC setup message (as discussed with reference to FIG. 3), an RRC resume message, or an RRC reconfiguration message.

At 415, the UE 115-c may identify the one or more parameters within the first subset that are modifiable based on the configuration received at 410 (e.g., the reconfiguration message or RRC reconfiguration message). In certain scenarios, the UE 115-c may identify these modifiable parameters based on established standards. Additionally, the UE 115-c may validate or fail to validate the parameters within the first subset. For example, the UE 115-c may assess the parameters associated with the configuration from the network entity 105-c to determine their validity based on the capabilities of the UE 115-c, prevailing conditions at the UE 115-c, or a combination thereof.

In response to a validation failure at 415, the UE 115-c may select between two options: the first option 405-a and the second option 405-b. The UE 115-c may execute the first option 405-a when a validation failure occurs and the parameters causing the failure are non-modifiable (e.g., non-recoverable, belonging to the second subset). Conversely, the UE 115-c may pursue the second option 405-b when a validation failure involves modifiable parameters (e.g., recoverable, belonging to the first subset). In certain instances, if the network entity 105-c rejects a modified value of one or more parameters set by the UE 115-c, the UE 115-c may revert back to the first option 405-a at 420.

At 420, as part of the first option 405-a, the UE 115-c may clean up the configuration (e.g., delete, erase, or remove one or more physical parameters of the configuration received at 410, perform a MAC reset, perform an ACQ+RACH procedure) and release the connection to the network entity 105-c.

At 425, as part of the first option 305-a, the UE 115-c may transmit a reestablishment request (e.g., RRC reestablishment request, rather than RRC reconfiguration complete) to the network entity 105-c to inform the network entity 105-c of an RLF. In response, the network entity 105-c may also clean up the configuration (e.g., delete, erase, or remove the configuration transmitted at 410). The network entity 105-c may be unaware of which parameter or parameters (e.g., IEs or configurations) in the setup message at 410 caused the failure. It may take hundreds of milliseconds or more for the UE 115-c to resynchronize with the network entity 105-c.

At 430, as part of the second option 405-b, the UE 115-c may modify (e.g., fix, update, correct) the value of at least one parameter based on a set of one or more capabilities of the UE 115-c, a set of one or more conditions at the UE 115-c, or a combination thereof. In some instances, the UE 115-c may modify the values of multiple parameters within the first subset of one or more parameters. Additionally, the UE 115-c may modify the value of the at least one parameter based on a validation failure of one or more parameters within the first subset at 415. Furthermore, the UE 115-c may modify the value of the at least one parameter based on a learning model (e.g., an algorithm), as described in more detail with reference to FIG. 5.

There are numerous methods by which the UE 115-c may modify (e.g., change, fix, correct) the value of the at least one parameter, and the examples described herein should not be construed as limiting. In some instances, the UE 115-c may modify the value of the at least one parameter by releasing at least one IE from a set of one or more IEs, where the at least one IE may correspond to the at least one parameter. Additionally, or alternatively, the UE 115-c may modify the value of the at least one parameter by setting at least one missing IE in the set of one or more IEs to a default value, where the at least one missing IE may correspond to the at least one parameter. Furthermore, the UE 115-c may modify the value of the at least one parameter by overwriting the value of the at least one parameter based on the parameter being unsupported by the set of capabilities of the UE 115-c. Alternatively, the UE 115-c may modify the value of the at least one parameter by selecting a value from one or more allowed values based on a performance metric of the UE 115-c and one or more QoS metrics. Additionally, the UE 115-c may modify the value of the at least one parameter by enabling support for the at least one parameter based at least in part on the set of one or more capabilities of the UE 115-c, wherein at least one capability indicates at least one of a supported carrier or a supported public land mobile network. The modified value of the at least one parameter may also be associated with an IE, a set of IEs, a carrier, a set of carriers, or any combination thereof. For example, the UE 115-c may modify the value of the at least one parameter within an IE, across multiple IEs, within a carrier, or across multiple carriers. In some instances, the modified value of the at least one parameter may correspond to the removal of a carrier.

At 435, the UE 115-c may transmit, and the network entity 105-c may receive, a second message (e.g., a modification message) that indicates the modified value of at least one parameter of the first subset of one or more parameters. For example, the modification message may be an UL-DCCH (reverse RRC reconfiguration) message or an UL-DCCH (RRC reconfiguration complete) message with one or more UE-updated configurations (e.g., RRC reconfiguration OCTET string including an indication of the modified value of the at least one parameter).

At 440, the network entity 105-c may validate the modified value of the at least one parameter. Specifically, the network entity 105-c may determine whether it can apply the modified value of the at least one parameter based on the result of the validation. In some examples, this may be based on whether the modified value meets a threshold, whether the modified value conflicts with other parameter values, and/or other criteria applied at the network entity 105-c. At 445, the network entity 105-c may transmit a feedback message.

At 445, the network entity 105-c may transmit, and the UE 115-c may receive, a third message (e.g., a feedback message) that provides feedback based at least in part on the second message indicating the modified value or values at 435. In some examples, the feedback may indicate acceptance or rejection of the modified value of the at least one parameter. If the modification is successfully validated by the network entity 105-c at 440, the feedback may indicate acceptance (e.g., an ACK, DL-DCCH (reverse-reconfiguration complete)), and the UE 115-c may successfully connect to the network entity 105-c (e.g., avoiding a time-intensive RLF and reestablishment procedure). If the modification validation fails at 440, the feedback may indicate rejection (e.g., a NACK, DL-DCCH (RRC reject, RRC release)), and the UE 115-c may undertake one or more actions associated with the first option 405-a (e.g., cleaning up and entering an idle mode at 420). In some instances, the feedback message may include at least one of an RRC setup complete message, an RRC reject message, an RRC release message, or a fallback RRC setup message.

FIG. 5 is an illustrative block diagram of an example ML architecture 500 that may be used for wireless communications in any of the various implementations, processes, environments, networks, or use cases listed above. As illustrated, architecture 500 includes multiple logical entities, such as model training host 502, model inference host 504, data source(s) 506, and agent 508. Model inference host 504 is configured to run an ML model based on inference data 512 provided by data source(s) 506. Model inference host 504 may produce output 514, which may include a prediction or inference, such as a discrete or continuous value based on inference data 512, which may then be provided as input to the agent 508.

Agent 508 may represent an element or an entity of a wireless communications system including, for example, a radio access network (RAN), a wireless local area network, a device-to-device (D2D) communications system, etc. As an example, agent 508 may be a UE (such as a UE 115 as described with reference to FIGS. 1 through 4), a base station (such as a base station 140 described with reference to FIG. 1), or a disaggregated network entity (such as a CU 160, a DU 165, an RU 170, or a network entity 105, as described with reference to FIG. 1), an access point (AP), a wireless station (STA), a RAN intelligent control (RIC) in a cloud-based RAN, among some examples. Additionally, agent 508 also may be a type of agent that depends on the type of tasks performed by model inference host 504, the type of inference data 512 provided to model inference host 504, or the type of output 514 produced by model inference host 504. For example, if output 514 from model inference host 504 is associated with modifying a value of one or more parameters of a first set of modifiable parameters, agent 508 may be or include a UE, a DU, or an RU. As another example, if output 514 from model inference host 504 is associated with adding or removing one or more parameters from the first set of modifiable parameters, agent 508 may be a CU or a DU.

Agent 508 may perform one or more actions associated with receiving output 514 from model inference host 504. For example, if agent 508 is a DU or an RU and the output from model inference host 504 is associated with modifying a value of one or more parameters of a first subset of modifiable parameters, agent 508 may determine the modified value of the one or more parameters of the first subset of modifiable parameters based on output 514. As another example, if agent 508 is a CU or a DU and the output from model inference host 504 is associated with adding or removing one or more parameters from the first subset of modifiable parameters, agent 508 may determine whether a first parameter belongs to the first subset of modifiable parameters. Agent 508 may indicate the one or more actions performed to at least one subject of action 510. For example, if the agent 508 determines to change or modify the value of the one or more parameters of the first subset of modifiable parameters, agent 508 may send a modification message (e.g., the modification message 215 described with reference to FIG. 2) to the subject of action 510 (such as, a network entity 105). In some cases, agent 508 and the subject of action 510 are the same entity.

Data can be collected from data sources 506, and may be used as training data 516 for training an ML model, or as inference data 512 for feeding an ML model inference operation. Data sources 506 may collect data from various subject of action 510 entities (such as, the UE 115 or the network entity 105), and provide the collected data to a model training host 502 for ML model training. For example, after a subject of action 510 (such as, a network entity 105) receives a modification message from agent 508, the subject of action 510 may provide performance feedback associated with the modification message to the data sources 506. The performance feedback (e.g., via the feedback message 220) may be used by the model training host 502 for monitoring or evaluating the ML model performance. In some examples, if output 514 provided to agent 508 is inaccurate (or the accuracy is below an accuracy threshold), model training host 502 may provide feedback to model inference host 504 to modify or retrain the ML model used by model inference host 504, such as via an ML model deployment update.

Model training host 502 may be deployed at the same or a different entity than that in which model inference host 504 is deployed. For example, in order to offload model training processing, which can impact the performance of model inference host 504, model training host 502 may be deployed at a model server.

In some aspects, an ML model is deployed at or on a network entity (such as a network entity 105 or a base station 140) for identifying one or more parameters of the first subset of modifiable parameters. More specifically, a model interference host, such as model inference host 504 in FIG. 5, may be deployed at or on the network entity for such identification.

In some other aspects, an ML model is deployed at or on a UE (such as a UE 115) for identification of one or more parameters of the first subset of modifiable parameters, for modification of the value of one or more parameters of the first subset of modifiable parameters, or for both. More specifically, a model inference host, such as model inference host 504 in FIG. 5, may be deployed at or on the UE for such identification, modification, or both.

In some aspects, the ML model may be collaboratively deployed across multiple entities such as one or more UEs 115 and a network entity 105, or across multiple network entities 105.

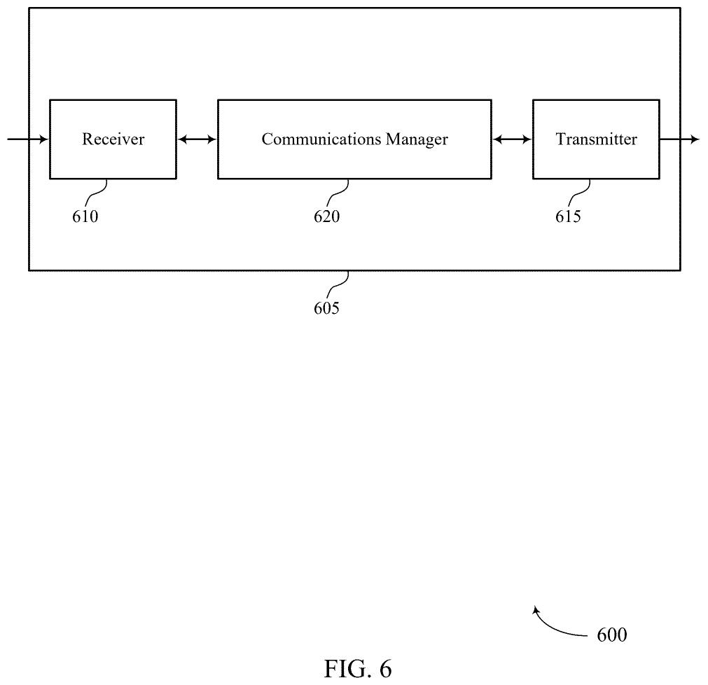

FIG. 6 shows a block diagram 600 of a device 605 that supports UE-assisted reconfigurations in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to UE-assisted reconfigurations). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UE-assisted reconfigurations). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of UE-assisted reconfigurations as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving a first message that indicates a configuration including a set of parameters, where the set of parameters includes a first subset of one or more parameters and a second subset of one or more parameters, where one or more parameters of the first subset of one or more parameters are modifiable by the device 605. The communications manager 620 is capable of, configured to, or operable to support a means for transmitting a second message that indicates a modified value of at least one parameter of the first subset of one or more parameters. The communications manager 620 is capable of, configured to, or operable to support a means for receiving a third message that indicates feedback based on the second message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

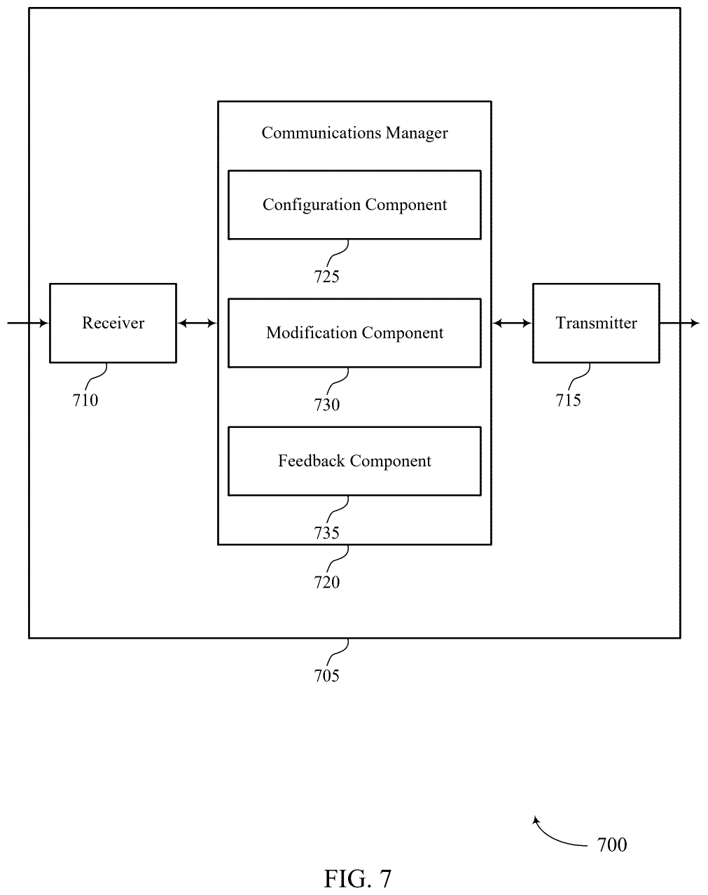

FIG. 7 shows a block diagram 700 of a device 705 that supports UE-assisted reconfigurations in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to UE-assisted reconfigurations). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to UE-assisted reconfigurations). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of UE-assisted reconfigurations as described herein. For example, the communications manager 720 may include a configuration component 725, a modification component 730, a feedback component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The configuration component 725 is capable of, configured to, or operable to support a means for receiving a first message that indicates a configuration including a set of parameters, where the set of parameters includes a first subset of one or more parameters and a second subset of one or more parameters, where one or more parameters of the first subset of one or more parameters are modifiable by the device 705. The modification component 730 is capable of, configured to, or operable to support a means for transmitting a second message that indicates a modified value of at least one parameter of the first subset of one or more parameters. The feedback component 735 is capable of, configured to, or operable to support a means for receiving a third message that indicates feedback based on the second message.

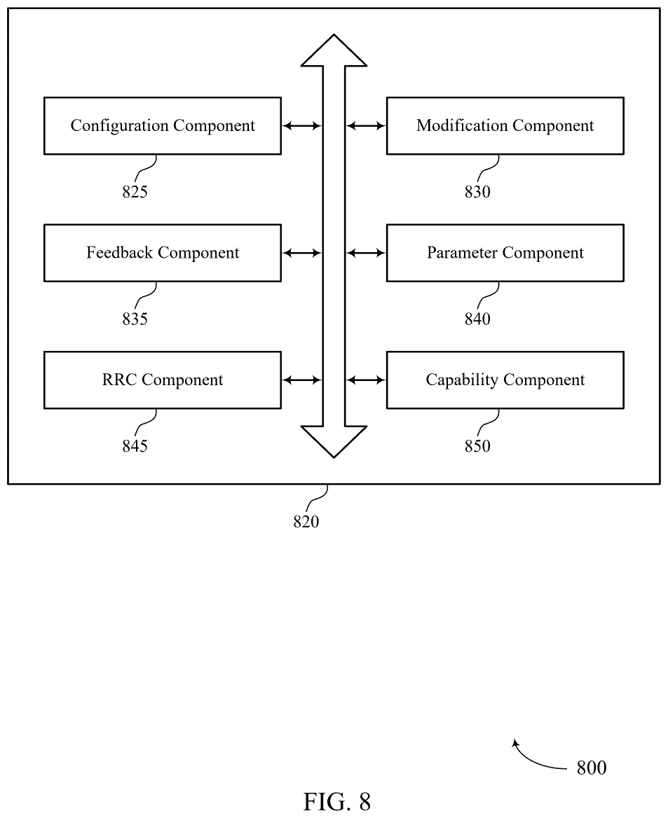

FIG. 8 shows a block diagram 800 of a communications manager 820 that supports UE-assisted reconfigurations in accordance with one or more aspects of the present disclosure. The communications manager 820 may be an example of aspects of a communications manager 620, a communications manager 720, or both, as described herein. The communications manager 820, or various components thereof, may be an example of means for performing various aspects of UE-assisted reconfigurations as described herein. For example, the communications manager 820 may include a configuration component 825, a modification component 830, a feedback component 835, a parameter component 840, an RRC component 845, a capability component 850, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The configuration component 825 is capable of, configured to, or operable to support a means for receiving a first message that indicates a configuration including a set of parameters, where the set of parameters includes a first subset of one or more parameters and a second subset of one or more parameters, where one or more parameters of the first subset of one or more parameters are modifiable by the UE. The modification component 830 is capable of, configured to, or operable to support a means for transmitting a second message that indicates a modified value of at least one parameter of the first subset of one or more parameters.

The feedback component 835 is capable of, configured to, or operable to support a means for receiving a third message that indicates feedback based on the second message.

In some examples, the parameter component 840 is capable of, configured to, or operable to support a means for identifying the one or more parameters of the first subset of one or more parameters that are modifiable by the UE (e.g., the device 605, the device 705, or the device 905) based on the configuration.

In some examples, the modification component 830 is capable of, configured to, or operable to support a means for modifying a value of the at least one parameter based on a set of one or more capabilities of the UE (e.g., the device 605, the device 705, or the device 905) or a set of one or more conditions at the UE (e.g., the device 605, the device 705, or the device 905), or any combination thereof.

In some examples, to support modifying the value of the at least one parameter, the modification component 830 is capable of, configured to, or operable to support a means for releasing at least one IE of a set of one or more IEs, where the at least one IE corresponds to the at least one parameter. In some examples, to modifying the value of the at least one parameter, the modification component 830 is capable of, configured to, or operable to support a means for setting at least one missing IE of the set of one or more IEs to a default value, where the at least one missing IE corresponds to the at least one parameter. In some examples, to support modifying the value of the at least one parameter, the modification component 830 is capable of, configured to, or operable to support a means for overwriting the value of the at least one parameter based on the at least one parameter being unsupported by the set of one or more capabilities of the UE (e.g., the device 605, the device 705, or the device 905). In some examples, to support modifying the value of the at least one parameter, the modification component 830 is capable of, configured to, or operable to support a means for setting the value of the at least one parameter to a value selected from one or more allowed values based on a performance metric of the UE (e.g., the device 605, the device 705, or the device 905) and one or more QoS metrics. In some examples, to support modifying the value of the at least one parameter, the modification component 830 is capable of, configured to, or operable to support a means for enabling support for the at least one parameter based on the set of one or more capabilities of the UE (e.g., the device 605, the device 705, or the device 905), where at least one capability of the set of one or more capabilities indicates at least one of a supported carrier or a supported public land mobile network.

In some examples, the feedback indicates an acceptance or a rejection of the modified value of the at least one parameter.

In some examples, the first message includes at least one of an RRC setup message, an RRC resume message, or an RRC reconfiguration message. In some examples, the second message includes at least one of an RRC setup complete message, a reverse RRC setup message, an RRC resume complete message, a reverse RRC resume message, an RRC reconfiguration complete message, or a reverse RRC reconfiguration message. In some examples, the third message includes at least one of a reverse RRC setup complete message, a reverse RRC resume complete message, a reverse RRC reconfiguration complete message, an RRC reject message, an RRC release message, or a fresh fallback RRC setup message.

In some examples, the modification component 830 is capable of, configured to, or operable to support a means for modifying a value of the at least one parameter based on a validation failure of the one or more parameters of the first subset of one or more parameters.

In some examples, the modified value of the at least one parameter is based on a learning model.

In some examples, the capability component 850 is capable of, configured to, or operable to support a means for transmitting a report including capability information that indicates whether the UE (e.g., the device 605, the device 705, or the device 905) supports a learning model for reconfiguration of the one or more parameters of the first subset of one or more parameters.

In some examples, the modified value of the at least one parameter is associated with an IE, a set of IEs, a carrier, or a set of carriers, or any combination thereof.

In some examples, the modified value of the at least one parameter corresponds to a removal of a carrier.

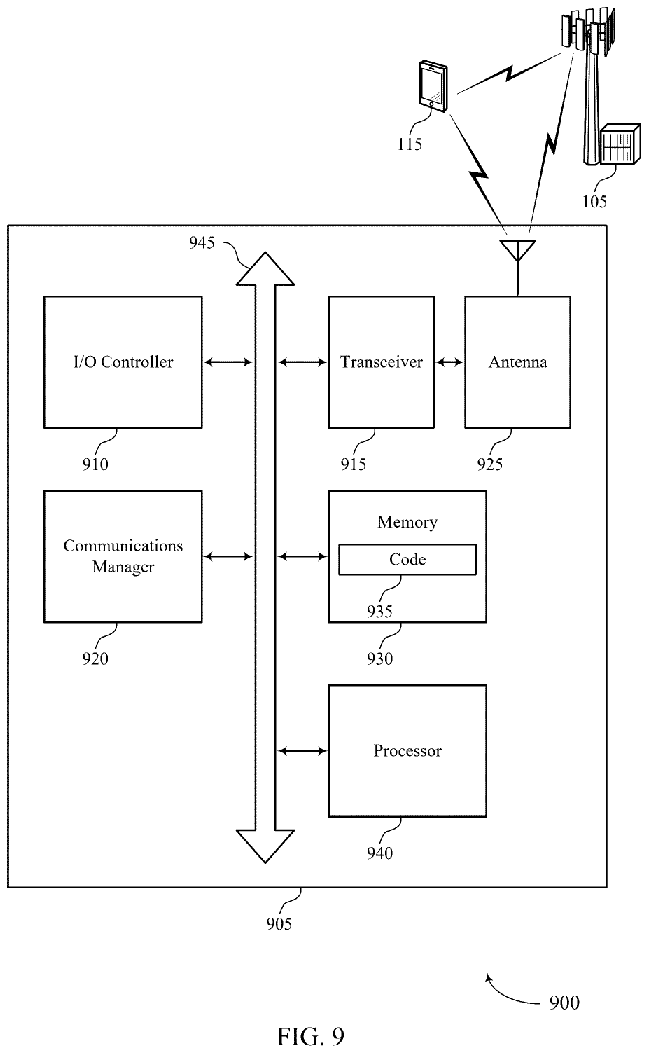

FIG. 9 shows a diagram of a system 900 including a device 905 that supports UE-assisted reconfigurations in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting UE-assisted reconfigurations). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving a first message that indicates a configuration including a set of parameters, where the set of parameters includes a first subset of one or more parameters and a second subset of one or more parameters, where one or more parameters of the first subset of one or more parameters are modifiable by the device 905. The communications manager 920 is capable of, configured to, or operable to support a means for transmitting a second message that indicates a modified value of at least one parameter of the first subset of one or more parameters. The communications manager 920 is capable of, configured to, or operable to support a means for receiving a third message that indicates feedback based on the second message.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, and longer battery life.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of UE-assisted reconfigurations as described herein, or the at least one processor 940 and the at least one memory 930 may be otherwise configured to, individually or collectively, perform or support such operations.

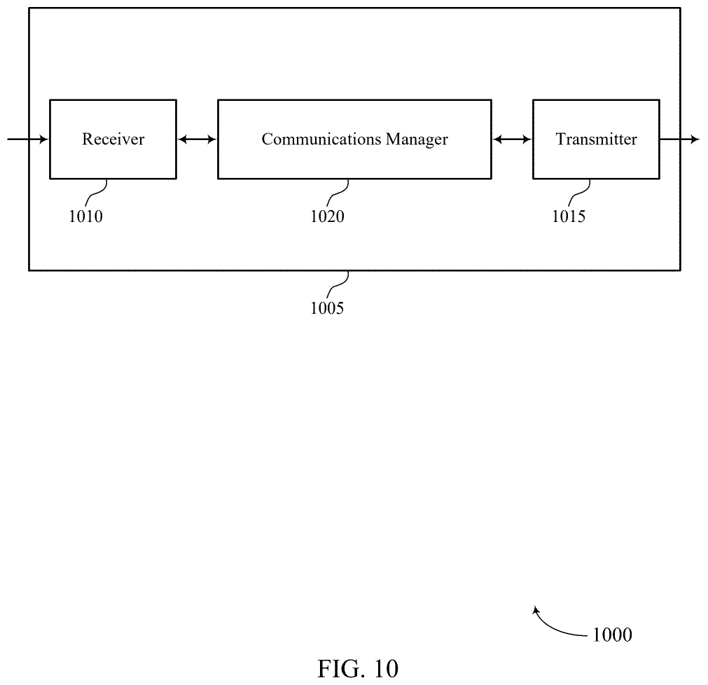

FIG. 10 shows a block diagram 1000 of a device 1005 that supports UE-assisted reconfigurations in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of UE-assisted reconfigurations as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE. The communications manager 1020 is capable of, configured to, or operable to support a means for obtaining a second message that indicates a modified value of at least one parameter of the first subset of one or more parameters. The communications manager 1020 is capable of, configured to, or operable to support a means for transmitting a third message that indicates feedback based on the second message.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

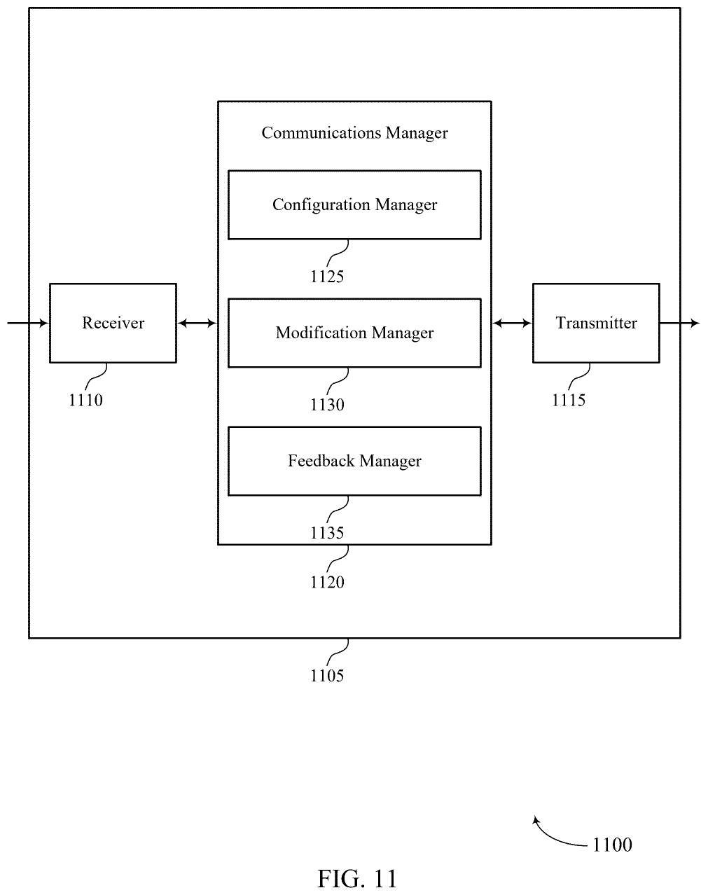

FIG. 11 shows a block diagram 1100 of a device 1105 that supports UE-assisted reconfigurations in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of UE-assisted reconfigurations as described herein. For example, the communications manager 1120 may include a configuration manager 1125, a modification manager 1130, a feedback manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The configuration manager 1125 is capable of, configured to, or operable to support a means for transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE. The modification manager 1130 is capable of, configured to, or operable to support a means for obtaining a second message that indicates a modified value of at least one parameter of the first subset of one or more parameters. The feedback manager 1135 is capable of, configured to, or operable to support a means for transmitting a third message that indicates feedback based on the second message.

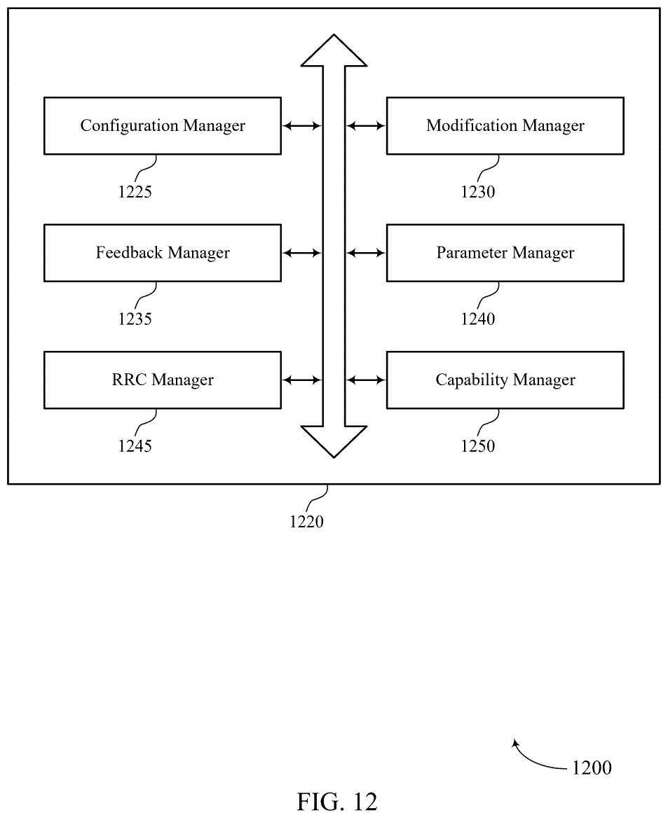

FIG. 12 shows a block diagram 1200 of a communications manager 1220 that supports UE-assisted reconfigurations in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of UE-assisted reconfigurations as described herein. For example, the communications manager 1220 may include a configuration manager 1225, a modification manager 1230, a feedback manager 1235, a parameter manager 1240, an RRC manager 1245, a capability manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The configuration manager 1225 is capable of, configured to, or operable to support a means for transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE. The modification manager 1230 is capable of, configured to, or operable to support a means for obtaining a second message that indicates a modified value of at least one parameter of the first subset of one or more parameters. The feedback manager 1235 is capable of, configured to, or operable to support a means for transmitting a third message that indicates feedback based on the second message.

In some examples, the parameter manager 1240 is capable of, configured to, or operable to support a means for identifying the one or more parameters of the first subset of one or more parameters that are modifiable by the UE based on the configuration.

In some examples, the feedback indicates an acceptance or a rejection of the modified value of the at least one parameter.

In some examples, the first message includes at least one of an RRC setup message, an RRC resume message, or an RRC reconfiguration message. In some examples, the second message includes at least one of an RRC setup complete message, a reverse RRC setup message, an RRC resume complete message, a reverse RRC resume message, an RRC reconfiguration complete message, or a reverse RRC reconfiguration message. In some examples, the third message includes at least one of a reverse RRC setup complete message, a reverse RRC resume complete message, a reverse RRC reconfiguration complete message, an RRC reject message, an RRC release message, or a fresh fallback RRC setup message.

In some examples, the modification manager 1230 is capable of, configured to, or operable to support a means for validating the modified value of the at least one parameter. In some examples, the feedback manager 1235 is capable of, configured to, or operable to support a means for generating the third message based on validating the modified value of the at least one parameter.

In some examples, the capability manager 1250 is capable of, configured to, or operable to support a means for obtaining a report including capability information that indicates whether the UE supports a learning model for reconfiguration of the one or more parameters of the first subset of one or more parameters.

In some examples, the modified value of the at least one parameter is associated with an IE, a set of IEs, a carrier, or a set of carriers, or any combination thereof.

In some examples, the modified value of the at least one parameter corresponds to a removal of a carrier.

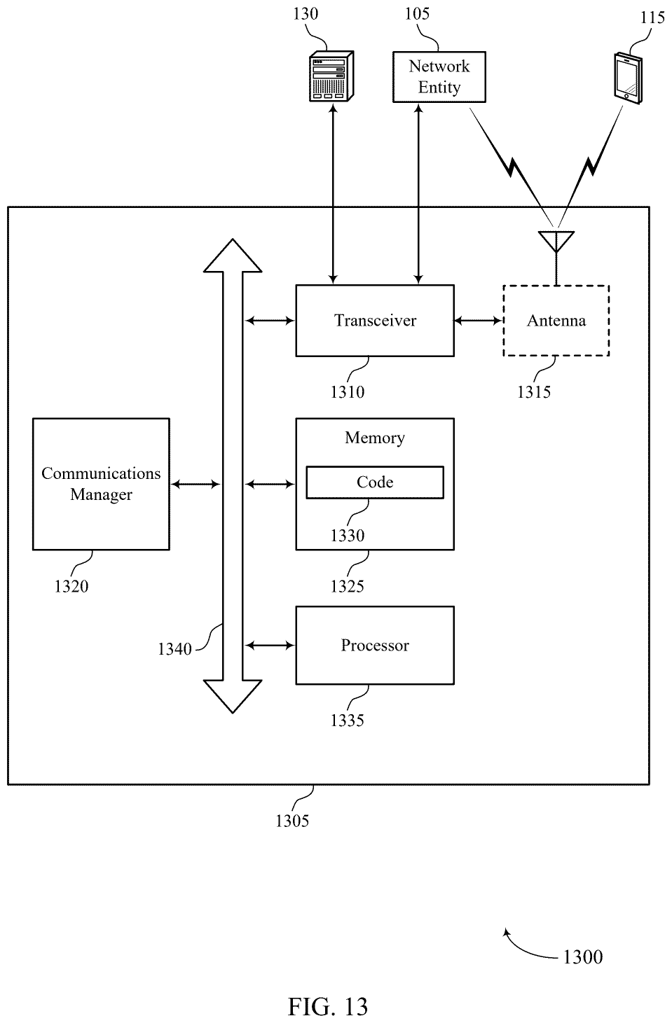

FIG. 13 shows a diagram of a system 1300 including a device 1305 that supports UE-assisted reconfigurations in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting UE-assisted reconfigurations). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE. The communications manager 1320 is capable of, configured to, or operable to support a means for obtaining a second message that indicates a modified value of at least one parameter of the first subset of one or more parameters. The communications manager 1320 is capable of, configured to, or operable to support a means for transmitting a third message that indicates feedback based on the second message.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, and longer battery life.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of UE-assisted reconfigurations as described herein, or the at least one processor 1335 and the at least one memory 1325 may be otherwise configured to, individually or collectively, perform or support such operations.

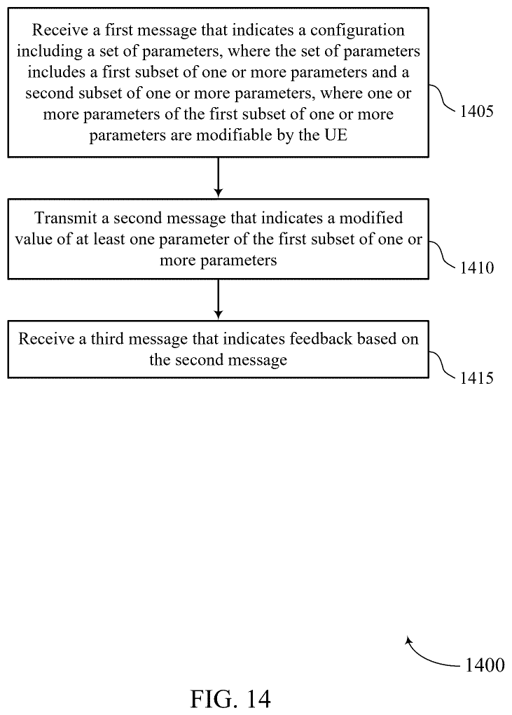

FIG. 14 shows a flowchart illustrating a method 1400 that supports UE-assisted reconfigurations in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first message that indicates a configuration including a set of parameters, where the set of parameters includes a first subset of one or more parameters and a second subset of one or more parameters, where one or more parameters of the first subset of one or more parameters are modifiable by the UE. The operations of 1405 may be performed in accordance with examples as disclosed herein. In some examples, aspects of the operations of 1405 may be performed by a configuration component 825 as described with reference to FIG. 8.

At 1410, the method may include transmitting a second message that indicates a modified value of at least one parameter of the first subset of one or more parameters. The operations of 1410 may be performed in accordance with examples as disclosed herein. In some examples, aspects of the operations of 1410 may be performed by a modification component 830 as described with reference to FIG. 8.

At 1415, the method may include receiving a third message that indicates feedback based on the second message. The operations of 1415 may be performed in accordance with examples as disclosed herein. In some examples, aspects of the operations of 1415 may be performed by a feedback component 835 as described with reference to FIG. 8.

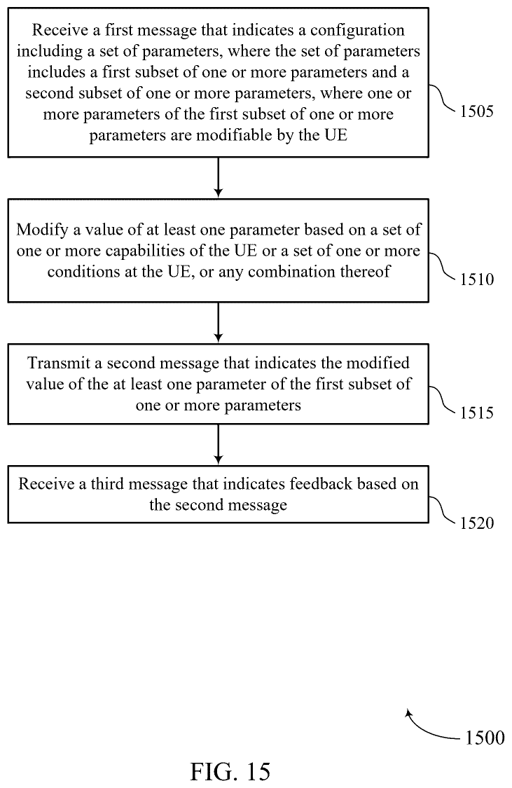

FIG. 15 shows a flowchart illustrating a method 1500 that supports UE-assisted reconfigurations in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a first message that indicates a configuration including a set of parameters, where the set of parameters includes a first subset of one or more parameters and a second subset of one or more parameters, where one or more parameters of the first subset of one or more parameters are modifiable by the UE. The operations of 1505 may be performed in accordance with examples as disclosed herein. In some examples, aspects of the operations of 1505 may be performed by a configuration component 825 as described with reference to FIG. 8.

At 1510, the method may include modifying a value of the at least one parameter based on a set of one or more capabilities of the UE or a set of one or more conditions at the UE, or any combination thereof. The operations of 1510 may be performed in accordance with examples as disclosed herein. In some examples, aspects of the operations of 1510 may be performed by a modification component 830 as described with reference to FIG. 8.

At 1515, the method may include transmitting a second message that indicates a modified value of at least one parameter of the first subset of one or more parameters. The operations of 1515 may be performed in accordance with examples as disclosed herein. In some examples, aspects of the operations of 1515 may be performed by a modification component 830 as described with reference to FIG. 8.

At 1520, the method may include receiving a third message that indicates feedback based on the second message. The operations of 1520 may be performed in accordance with examples as disclosed herein. In some examples, aspects of the operations of 1520 may be performed by a feedback component 835 as described with reference to FIG. 8.

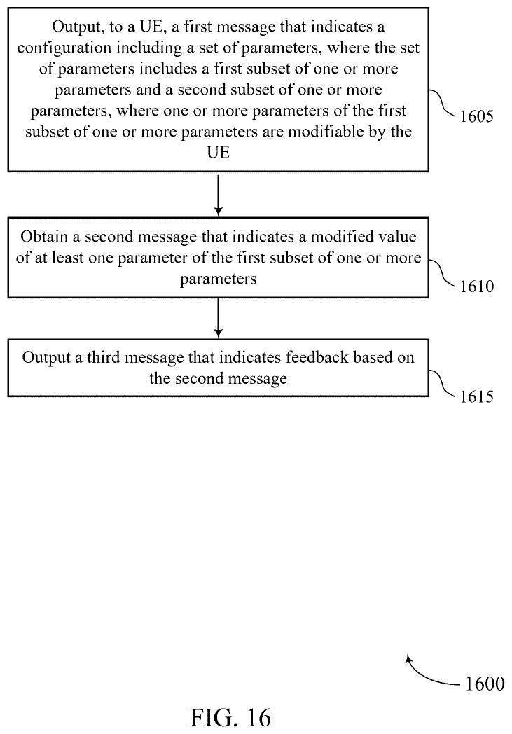

FIG. 16 shows a flowchart illustrating a method 1600 that supports UE-assisted reconfigurations in accordance with one or more aspects of the present disclosure. The operations of the method 1600 may be implemented by a network entity or its components as described herein. For example, the operations of the method 1600 may be performed by a network entity 105 as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE. The operations of 1605 may be performed in accordance with examples as disclosed herein. In some examples, aspects of the operations of 1605 may be performed by a configuration manager 1225 as described with reference to FIG. 12.

At 1610, the method may include obtaining a second message that indicates a modified value of at least one parameter of the first subset of one or more parameters. The operations of 1610 may be performed in accordance with examples as disclosed herein. In some examples, aspects of the operations of 1610 may be performed by a modification manager 1230 as described with reference to FIG. 12.

At 1615, the method may include transmitting a third message that indicates feedback based on the second message. The operations of 1615 may be performed in accordance with examples as disclosed herein. In some examples, aspects of the operations of 1615 may be performed by a feedback manager 1235 as described with reference to FIG. 12.

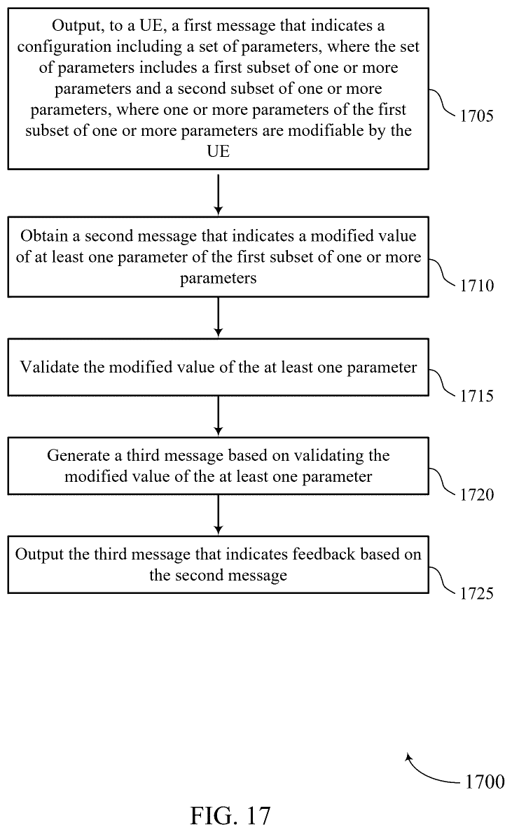

FIG. 17 shows a flowchart illustrating a method 1700 that supports UE-assisted reconfigurations in accordance with one or more aspects of the present disclosure. The operations of the method 1700 may be implemented by a network entity or its components as described herein. For example, the operations of the method 1700 may be performed by a network entity 105 as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, a first message that indicates a configuration including a set of parameters, where the set of parameters includes a first subset of one or more parameters and a second subset of one or more parameters, where one or more parameters of the first subset of one or more parameters are modifiable by the UE. The operations of 1705 may be performed in accordance with examples as disclosed herein. In some examples, aspects of the operations of 1705 may be performed by a configuration manager 1225 as described with reference to FIG. 12.

At 1710, the method may include obtaining a second message that indicates a modified value of at least one parameter of the first subset of one or more parameters. The operations of 1710 may be performed in accordance with examples as disclosed herein. In some examples, aspects of the operations of 1710 may be performed by a modification manager 1230 as described with reference to FIG. 12.

At 1715, the method may include validating the modified value of the at least one parameter. The operations of 1715 may be performed in accordance with examples as disclosed herein. In some examples, aspects of the operations of 1715 may be performed by a modification manager 1230 as described with reference to FIG. 12.

At 1720, the method may include generating the third message based on validating the modified value of the at least one parameter. The operations of 1720 may be performed in accordance with examples as disclosed herein. In some examples, aspects of the operations of 1720 may be performed by a feedback manager 1235 as described with reference to FIG. 12.

At 1725, the method may include transmitting a third message that indicates feedback based on the second message. The operations of 1725 may be performed in accordance with examples as disclosed herein. In some examples, aspects of the operations of 1725 may be performed by a feedback manager 1235 as described with reference to FIG. 12.

The following provides an overview of aspects of the present disclosure:

Aspect 1: A method for wireless communication at a UE, comprising: receiving a first message that indicates a configuration comprising a set of parameters, wherein the set of parameters comprises a first subset of one or more parameters and a second subset of one or more parameters, wherein one or more parameters of the first subset of one or more parameters are modifiable by the UE; transmitting a second message that indicates a modified value of at least one parameter of the first subset of one or more parameters; and receiving a third message that indicates feedback based at least in part on the second message.

Aspect 2: The method of aspect 1, further comprising: identifying the one or more parameters of the first subset of one or more parameters that are modifiable by the UE based at least in part on the configuration.

Aspect 3: The method of any of aspects 1 through 2, further comprising: modifying a value of the at least one parameter based at least in part on a set of one or more capabilities of the UE or a set of one or more conditions at the UE, or any combination thereof.

Aspect 4: The method of aspect 3, wherein modifying the value of the at least one parameter comprises at least one of: releasing at least one information element (IE) of a set of one or more IEs, wherein the at least one IE corresponds to the at least one parameter; setting at least one missing IE of the set of one or more IEs to a default value, wherein the at least one missing IE corresponds to the at least one parameter; overwriting the value of the at least one parameter based at least in part on the at least one parameter being unsupported by the set of one or more capabilities of the UE; setting the value of the at least one parameter to a value selected from one or more allowed values based at least in part on a performance metric of the UE and one or more quality of service (QoS) metrics; or enabling support for the at least one parameter based at least in part on the set of one or more capabilities of the UE, wherein at least one capability of the set of one or more capabilities indicates at least one of a supported carrier or a supported public land mobile network.

Aspect 5: The method of any of aspects 1 through 4, wherein the feedback indicates an acceptance or a rejection of the modified value of the at least one parameter.

Aspect 6: The method of any of aspects 1 through 5, wherein the first message comprises at least one of an RRC setup message, an RRC setup complete message, or an RRC reconfiguration message; and the third message comprises at least one of an RRC setup complete message, an RRC reject message, an RRC release message, or an RRC reconfiguration complete message.

Aspect 7: The method of any of aspects 1 through 6, further comprising: modifying a value of the at least one parameter based at least in part on a validation failure of the one or more parameters of the first subset of one or more parameters.

Aspect 8: The method of any of aspects 1 through 7, wherein the modified value of the at least one parameter is based at least in part on a learning model.

Aspect 9: The method of any of aspects 1 through 8, further comprising: transmitting a report comprising capability information that indicates whether the UE supports a learning model for reconfiguration of the one or more parameters of the first subset of one or more parameters.

Aspect 10: The method of any of aspects 1 through 9, wherein the modified value of the at least one parameter is associated with an information element (IE), a set of IEs, a carrier, or a set of carriers, or any combination thereof.

Aspect 11: The method of any of aspects 1 through 10, wherein the modified value of the at least one parameter corresponds to a removal of a carrier.

Aspect 12: A method for wireless communication at a network entity, comprising: transmitting, to a UE, a first message that indicates a configuration comprising a set of parameters, wherein the set of parameters comprises a first subset of one or more parameters and a second subset of one or more parameters, wherein one or more parameters of the first subset of one or more parameters are modifiable by the UE; obtaining a second message that indicates a modified value of at least one parameter of the first subset of one or more parameters; and transmitting a third message that indicates feedback based at least in part on the second message.

Aspect 13: The method of aspect 12, further comprising: identifying the one or more parameters of the first subset of one or more parameters that are modifiable by the UE based at least in part on the configuration.

Aspect 14: The method of any of aspects 12 through 13, wherein the feedback indicates an acceptance or a rejection of the modified value of the at least one parameter.

Aspect 15: The method of any of aspects 12 through 14, wherein the first message comprises at least one of an RRC setup message, an RRC setup complete message, or an RRC reconfiguration message; and the third message comprises at least one of an RRC setup complete message, an RRC reject message, an RRC release message, or an RRC reconfiguration complete message.

Aspect 16: The method of any of aspects 12 through 15, further comprising: validating the modified value of the at least one parameter; and generating the third message based at least in part on validating the modified value of the at least one parameter.

Aspect 17: The method of any of aspects 12 through 16, further comprising: obtaining a report comprising capability information that indicates whether the UE supports a learning model for reconfiguration of the one or more parameters of the first subset of one or more parameters.

Aspect 18: The method of any of aspects 12 through 17, wherein the modified value of the at least one parameter is associated with an information element (IE), a set of IEs, a carrier, or a set of carriers, or any combination thereof.

Aspect 19: The method of any of aspects 12 through 18, wherein the modified value of the at least one parameter corresponds to a removal of a carrier.

Aspect 20: A UE for wireless communication, comprising one or more memories storing processor-executable code, and one or more processors coupled with the one or more memories and individually or collectively operable to execute the code to cause the UE to perform a method of any of aspects 1 through 11.

Aspect 21: A UE for wireless communication, comprising at least one means for performing a method of any of aspects 1 through 11.

Aspect 22: A non-transitory computer-readable medium storing code for wireless communication, the code comprising instructions executable by one or more processors to perform a method of any of aspects 1 through 11.

Aspect 23: A network entity for wireless communication, comprising one or more memories storing processor-executable code, and one or more processors coupled with the one or more memories and individually or collectively operable to execute the code to cause the network entity to perform a method of any of aspects 12 through 19.

Aspect 24: A network entity for wireless communication, comprising at least one means for performing a method of any of aspects 12 through 19.

Aspect 25: A non-transitory computer-readable medium storing code for wireless communication, the code comprising instructions executable by one or more processors to perform a method of any of aspects 12 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message that indicates a configuration comprising a set of parameters, wherein the set of parameters comprises a first subset of one or more parameters and a second subset of one or more parameters, wherein one or more parameters of the first subset of one or more parameters are modifiable by the UE;
transmit a second message that indicates a modified value of at least one parameter of the first subset of one or more parameters; and
receive a third message that indicates feedback based at least in part on the second message.

2. The UE of claim 1, wherein the one or more processors are individually or collectively further operable to execute the code to cause the UE to:
identify the one or more parameters of the first subset of one or more parameters that are modifiable by the UE based at least in part on the configuration.

3. The UE of claim 1, wherein the one or more processors are individually or collectively further operable to execute the code to cause the UE to:
modify a value of the at least one parameter based at least in part on a set of one or more capabilities of the UE or a set of one or more conditions at the UE, or any combination thereof.

4. The UE of claim 3, wherein, to modify the value of the at least one parameter, the one or more processors are individually or collectively operable to execute the code to cause the UE to:
release at least one information element (IE) of a set of one or more IEs, wherein the at least one IE corresponds to the at least one parameter;
set at least one missing IE of the set of one or more IEs to a default value, wherein the at least one missing IE corresponds to the at least one parameter;
overwrite the value of the at least one parameter based at least in part on the at least one parameter being unsupported by the set of one or more capabilities of the UE;
set the value of the at least one parameter to a value selected from one or more allowed values based at least in part on a performance metric of the UE and one or more quality of service (QoS) metrics; or
enable support for the at least one parameter based at least in part on the set of one or more capabilities of the UE, wherein at least one capability of the set of one or more capabilities indicates at least one of a supported carrier or a supported public land mobile network.

5. The UE of claim 1, wherein the feedback indicates an acceptance or a rejection of the modified value of the at least one parameter.

6. The UE of claim 1, wherein:
the first message comprises at least one of a radio resource control (RRC) setup message, an RRC resume message, or an RRC reconfiguration message;
the second message comprises at least one of an RRC setup complete message, a reverse RRC setup message, an RRC resume complete message, a reverse RRC resume message, an RRC reconfiguration complete message, or a reverse RRC reconfiguration message; and
the third message comprises at least one of a reverse RRC setup complete message, a reverse RRC resume complete message, a reverse RRC reconfiguration complete message, an RRC reject message, an RRC release message, or a fresh fallback RRC setup message.

7. The UE of claim 1, wherein the one or more processors are individually or collectively further operable to execute the code to cause the UE to:
modify a value of the at least one parameter based at least in part on a validation failure of the one or more parameters of the first subset of one or more parameters.

8. The UE of claim 1, wherein the modified value of the at least one parameter is based at least in part on a learning model.

9. The UE of claim 1, wherein the one or more processors are individually or collectively further operable to execute the code to cause the UE to:
transmit a report comprising capability information that indicates whether the UE supports a learning model for reconfiguration of the one or more parameters of the first subset of one or more parameters.

10. The UE of claim 1, wherein the modified value of the at least one parameter is associated with an information element (IE), a set of IEs, a carrier, or a set of carriers, or any combination thereof.

11. The UE of claim 1, wherein the modified value of the at least one parameter corresponds to a removal of a carrier.

12. A network entity, comprising:
one or more memories storing processor-executable code; and
one or more processors coupled with the one or more memories and individually or collectively operable to execute the code to cause the network entity to:
transmit, to a user equipment (UE), a first message that indicates a configuration comprising a set of parameters, wherein the set of parameters comprises a first subset of one or more parameters and a second subset of one or more parameters, wherein one or more parameters of the first subset of one or more parameters are modifiable by the UE;
obtain a second message that indicates a modified value of at least one parameter of the first subset of one or more parameters; and
transmit a third message that indicates feedback based at least in part on the second message.

13. The network entity of claim 12, wherein the one or more processors are individually or collectively further operable to execute the code to cause the network entity to:
identify the one or more parameters of the first subset of one or more parameters that are modifiable by the UE based at least in part on the configuration.

14. The network entity of claim 12, wherein the feedback indicates an acceptance or a rejection of the modified value of the at least one parameter.

15. The network entity of claim 12, wherein:
the first message comprises at least one of a radio resource control (RRC) setup message, an RRC resume message, or an RRC reconfiguration message;
the second message comprises at least one of an RRC setup complete message, a reverse RRC setup message, an RRC resume complete message, a reverse RRC resume message, an RRC reconfiguration complete message, or a reverse RRC reconfiguration message; and
the third message comprises at least one of a reverse RRC setup complete message, a reverse RRC resume complete message, a reverse RRC reconfiguration complete message, an RRC reject message, an RRC release message, or a fresh fallback RRC setup message.

16. The network entity of claim 12, wherein the one or more processors are individually or collectively further operable to execute the code to cause the network entity to:
validate the modified value of the at least one parameter; and
generate the third message based at least in part on validating the modified value of the at least one parameter.

17. The network entity of claim 12, wherein the one or more processors are individually or collectively further operable to execute the code to cause the network entity to:
obtain a report comprising capability information that indicates whether the UE supports a learning model for reconfiguration of the one or more parameters of the first subset of one or more parameters.

18. The network entity of claim 12, wherein the modified value of the at least one parameter is associated with an information element (IE), a set of IEs, a carrier, or a set of carriers, or any combination thereof.

19. The network entity of claim 12, wherein the modified value of the at least one parameter corresponds to a removal of a carrier.

20. A method for wireless communication at a user equipment (UE), comprising:
receiving a first message that indicates a configuration comprising a set of parameters, wherein the set of parameters comprises a first subset of one or more parameters and a second subset of one or more parameters, wherein one or more parameters of the first subset of one or more parameters are modifiable by the UE;
transmitting a second message that indicates a modified value of at least one parameter of the first subset of one or more parameters; and
receiving a third message that indicates feedback based at least in part on the second message.

21. The method of claim 20, further comprising:
identifying the one or more parameters of the first subset of one or more parameters that are modifiable by the UE based at least in part on the configuration.

22. The method of claim 20, further comprising:
modifying a value of the at least one parameter based at least in part on a set of one or more capabilities of the UE or a set of one or more conditions at the UE, or any combination thereof.

23. The method of claim 22, wherein modifying the value of the at least one parameter comprises at least one of:
releasing at least one information element (IE) of a set of one or more IEs, wherein the at least one IE corresponds to the at least one parameter;
setting at least one missing IE of the set of one or more IEs to a default value, wherein the at least one missing IE corresponds to the at least one parameter;
overwriting the value of the at least one parameter based at least in part on the at least one parameter being unsupported by the set of one or more capabilities of the UE;
setting the value of the at least one parameter to a value selected from one or more allowed values based at least in part on a performance metric of the UE and one or more quality of service (QoS) metrics; or
enabling support for the at least one parameter based at least in part on the set of one or more capabilities of the UE, wherein at least one capability of the set of one or more capabilities indicates at least one of a supported carrier or a supported public land mobile network.

24. The method of claim 20, wherein the feedback indicates an acceptance or a rejection of the modified value of the at least one parameter.

25. The method of claim 20, further comprising:
modifying a value of the at least one parameter based at least in part on a validation failure of the one or more parameters of the first subset of one or more parameters.

26. A method for wireless communication at a network entity, comprising:
transmitting, to a user equipment (UE), a first message that indicates a configuration comprising a set of parameters, wherein the set of parameters comprises a first subset of one or more parameters and a second subset of one or more parameters, wherein one or more parameters of the first subset of one or more parameters are modifiable by the UE;
obtaining a second message that indicates a modified value of at least one parameter of the first subset of one or more parameters; and
transmitting a third message that indicates feedback based at least in part on the second message.

27. The method of claim 26, further comprising:
identifying the one or more parameters of the first subset of one or more parameters that are modifiable by the UE based at least in part on the configuration.

28. The method of claim 26, wherein the feedback indicates an acceptance or a rejection of the modified value of the at least one parameter.

29. The method of claim 26, further comprising:
validating the modified value of the at least one parameter; and
generating the third message based at least in part on validating the modified value of the at least one parameter.

30. The method of claim 26, further comprising:
obtaining a report comprising capability information that indicates whether the UE supports a learning model for reconfiguration of the one or more parameters of the first subset of one or more parameters.
